(19) United States
(12) Patent Application Publication
(10) Pub. No.: US 2013/0314765 A1
(43) Pub. Date: Nov. 28, 2013

(54) Metamaterial Devices with Environmentally Responsive Materials

(71) Applicant: The Trustees of Boston College, Chestnut Hill, MA (US)

(72) Inventors: Willie J. Padilla, Newton, MA (US); Salvatore Savo, Brighton, MA (US); Christopher M. Bingham, Bellingham, MA (US); David Shrekenhamer, Brighton, MA (US); Wen-Chen Chen, Cambridge, MA (US)

(73) Assignee: The Trustees of Boston College, Chestnut Hill, MA (US)

(21) Appl. No.: 13/902,423

(22) Filed: May 24, 2013

Related U.S. Application Data
(60) Provisional application No. 61/651,727, filed on May 25, 2012.

(51) Int. Cl. G01K 7/00; G02F 1/00

(52) U.S. Cl. CPC G01K 7/003; G02F 1/0018
USPC 359/315; 374/163; 428/209

(57) ABSTRACT

Metamaterial devices with environmentally responsive materials are disclosed. In some embodiments, a metamaterial perfect absorber includes a first patterned metallic layer, a second metallic layer electrically isolated from the first patterned metallic layer by a gap, and an environmentally responsive dielectric material positioned in the gap between the first patterned metallic layer and the metallic second layer.

### RELATED APPLICATIONS

This application claims the benefit of and priority to U.S. Provisional Application No. 61/651,727, filed on May 25, 2012, and which is incorporated herein by reference in its entirety.

### FIELD

The embodiments disclosed herein relate to metamaterial super absorbers and devices based on metamaterial super absorbers.

### BACKGROUND

Imaging in the electromagnetic spectrum lying between roughly 0.3 and 3 THz—the so-called “Terahertz Gap”—can be used for a variety of applications, ranging from novel cancer detection methods to deepening our understanding of the universes creation. Other relevant areas of the electromagnetic spectrum include the infrared (IR) region where growth has been similarly limited. The development of a new class of THz and IR detectors would create new opportunities for growth in the field of THz and IR science and technology.

### SUMMARY

Metamaterial devices with environmentally responsive materials are disclosed herein. According to some aspects illustrated herein, there is provided a metamaterial perfect absorber that includes a first patterned metallic layer, a second metallic layer electrically isolated from the first patterned metallic layer by a gap, and an environmentally responsive dielectric material positioned in the gap between the first patterned metallic layer and the metallic second layer.

According to some aspects illustrated herein, there is provided a detector that includes a first patterned metallic layer, a second metallic layer electrically isolated from the first patterned metallic layer by a gap, and a pyroelectric material disposed in the gap between the first patterned metallic layer and the second metallic layer, and a voltage meter configured to record voltage generated in the pyroelectric material due to a change in temperature in the pyroelectric material.

According to some aspects illustrated herein, there is provided a spatial light modulator that includes a plurality of pixels, each pixel comprising a first patterned metallic layer, a second metallic layer electrically isolated from the first patterned metallic layer by a gap, and a phase change material positioned in the gap between the first patterned metallic layer and the second metallic layer, and a biasing source electrically connected to the pixels to switch the pixels between an absorption state and a reflection state.

According to some aspects illustrated herein, there is provided an imaging system that includes a source of radiation to irradiate an object to be imaged, a spatial light modulator having a plurality of pixels, each pixel comprising a first patterned metallic layer, a second metallic layer electrically isolated from the first patterned metallic layer by a gap, and a phase change material positioned in the gap between the first patterned metallic layer and the second metallic layer, and a biasing source electrically connected to the pixels to switch the pixels between an absorption state and a reflection state, and a radiation detector, wherein the spatial light modulator is configured to receive radiation reflected from the object and to reflect the radiation in a desired manner to the radiation detector.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1A is a schematic diagram of an embodiment metamaterial perfect absorber (MMPA) of the present disclosure.

FIG. 1B presents absorption response for dielectrics with different loss tangents and a variety of thicknesses.

FIG. 1C is an embodiment of an MMPA of the present disclosure.

FIG. 2 is a schematic diagram of an embodiment of a layer of an MMPA of the present disclosure.

FIG. 3A, FIG. 3B, FIG. 3C, FIG. 3D and FIG. 3E illustrate various embodiments of resonators suitable for use in an MMPA of the present disclosure.

FIG. 4A, FIG. 4B, FIG. 4C, FIG. 4D, FIG. 4E, FIG. 4F, FIG. 4G, FIG. 4H, and FIG. 4I illustrate additional various embodiments of resonators suitable for use in an MMPA of the present disclosure.

FIG. 5A, FIG. 5B, FIG. 5C, FIG. 5D, FIG. 5E, FIG. 5F, FIG. 5G, and FIG. 5H illustrate additional various embodiments of resonators suitable for use in an MMPA of the present disclosure.

FIG. 6A, FIG. 6B, FIG. 6C, and FIG. 6D illustrate additional various embodiments of resonators suitable for use in an MMPA of the present disclosure.

FIG. 7A, FIG. 7B, FIG. 7C, FIG. 7D, FIG. 7E, FIG. 7F, FIG. 7G, and FIG. 7H illustrate additional various embodiments of resonators suitable for use in an MMPA of the present disclosure.

FIG. 8A and FIG. 8B illustrate a principal of operation of an MMPA of the present disclosure with one or more pyroelectric materials.

FIG. 8C illustrates an embodiment of a pyroelectric detector of the instant disclosure.

FIG. 8D illustrates an embodiment of a circuit diagram for a pyroelectric detector system of the present disclosure.

FIG. 9A and FIG. 9B illustrate a principal of operation of an MMPA of the present disclosure with one or more phase change materials.

FIG. 10A illustrates a principal of operation of a spatial light modulator based on an MMPA of the present disclosure with one or more phase change materials.

FIG. 10B illustrates an embodiment of an imaging system for non-destructive evaluation using a spatial light modulator based on an MMPA of the present disclosure.

FIG. 10C illustrates an embodiment of an imaging system for non-destructive evaluation using a spatial light modulator based on an MMPA of the present disclosure.

FIG. 11A illustrates a top view of an embodiment multiple-pixel MMPA-based device of the present disclosure, showing an 8×8 pixel array and connection electrodes.

FIG. 11B illustrates an enhanced view of a region of several pixels of the device of FIG. 11A.

FIG. 11C illustrates a further enhanced view of a single pixel of the device of FIG. 11A, showing a potential arrangement of a metamaterial pattern with individual unit cells connected to create the full pad.

FIG. 12A, FIG. 12B, FIG. 12C, FIG. 12D and FIG. 12E present design and operational principle of an embodiment tunable metamaterial perfect absorber of the present disclosure.

FIG. 12A is a schematic of a single unit cell of a metamaterial perfect absorber with liquid crystal in the unbiased state. FIG. 12B is an optical microscope image of a metamaterial array. FIG. 12C presents a simulation of the electric field vector produced from an applied bias between electric ring resonator (ERR) resonator and ground plane. FIG. 12D illustrates random alignment of liquid crystals in an unbiased state (right) and for applied AC bias (left).

FIG. 12E presents absolute value of the electric field vector produced from an applied bias between electric ring resonator (ERR) resonator and ground plane.

FIG. 13A, FIG. 13B, and FIG. 13C present experimentally measured THz absorption of an embodiment metamaterial perfect absorber of the present disclosure. FIG. 13A is a graph showing frequency location of the absorption maximum (Aₘₐₓ) as a function of applied bias voltage (V_{bias}) for modulation frequency (fbias) values of 373 Hz, 1 kHz, 10 kHz, and 100 kHz. FIG. 13B is a graph showing frequency dependent absorption A(ω) for 0 V and 4 V at f_{bias}=1 kHz, dashed line is centered at Amax(V_{bias}=0 V)=2.62 THz. FIG. 13C is a graph showing the absorption value at 2.62 THz as a function of V_{bias} for various modulation frequencies.

FIG. 14A and FIG. 14B present numerical simulations of an embodiment metamaterial perfect absorber of the present disclosure. FIG. 14A presents results of THz absorption simulated for 0 V at f_{mod}=1 kHz. FIG. 14B presents simulated current density in the ERR for the case of the unbiased absorption maximum Aₘₐₓ (V_{bias}=0)=2.62 THz.

FIG. 15A, FIG. 15B, FIG. 15C, and FIG. 15D present resonant terahertz fields of an embodiment metamaterial perfect absorber of the present disclosure. FIG. 15A and FIG. 15B present a simulated electric field and power loss density (P), respectively, shown at a plane between the two metallization. FIG. 15C and FIG. 15D present terahertz electric vector plot and power loss density, respectively, shown for a crass sectional cut represented by dashed line in FIG. 15A and FIG. 15B.

FIG. 16A and FIG. 16B present effective constants of an embodiment, metamaterial perfect absorber of the present disclosure. FIG. 16A is a graph showing real part of effective permeability (μ_{1, eff}) determined from inversion of the simulated scattering parameters for 0 V and 4 V. FIG. 16B is a graph showing real part of effective permittivity (∈_{1, eff}) determined from inversion of the simulated scattering parameters for 0 V and 4 V.

FIG. 17A is a representation of a metamaterial absorber used in Example 2.

FIG. 17B is an optical microscope image of the metamaterial absorber that was fabricated for use in Example 2 with a single unit cell having the dimensions as labeled in the inset.

FIG. 17C shows a schematic of the cross section of a metamaterial absorber unit cell filled with LCs and the corresponding biasing scheme.

FIG. 18A is a plot of the measured absorptivity of the metamaterial absorber as a function of the frequency, showing biased state and unbiased state (i.e. the absorption of EM energy when the time varying electric field is applied).

FIG. 18B is a plot of the modulation factor M as a function of the frequency.

FIG. 19A is a plot of the modeled absorptivity of the metamaterial absorber as a function of the frequency.

FIG. 19B and FIG. 19C show plots of the energy dissipation from the modeled metamaterial absorber of FIG. 19A at frequencies f₁ and f₂, respectively.

FIG. 20A is a representation of a metamaterial absorber used in Example 3.

FIG. 20B is a photograph of the spatial light modulator (SLM) of Example 3.

FIG. 20C is an optical microscope image of the metamaterial perfect absorber used in Example 3 and the corresponding unit cell dimension.

FIG. 21A and FIG. 21B show the pixelated maps of the absorptivity at f=3.7 THz in the unbiased and biased case respectively.

FIG. 21C is a plot of the percentage frequency shift of the SLM as a function of the number of pixels.

FIG. 21D is a plot of the percent modulation of the SLM as a function of the number of pixels.

FIG. 22A is a plot of the absorptivity as a function of the frequency in a biased and unbiased state.

FIG. 22B illustrates the spatial distribution of the intensity of the electric field inside the liquid crystal and polyimide layers at resonance.

FIG. 23 is the intensity map showing a pixellated image of a cross pattern created by turning off only selected pixels at 3.725 THz.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

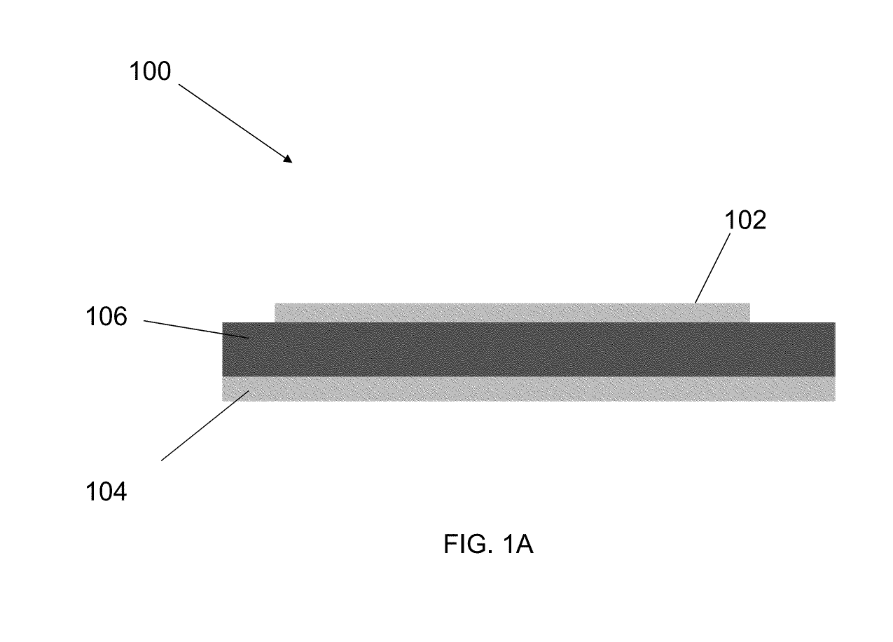

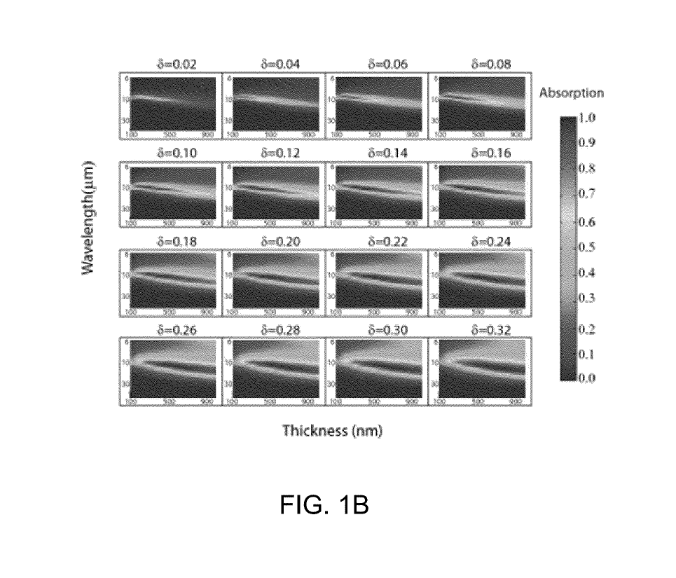

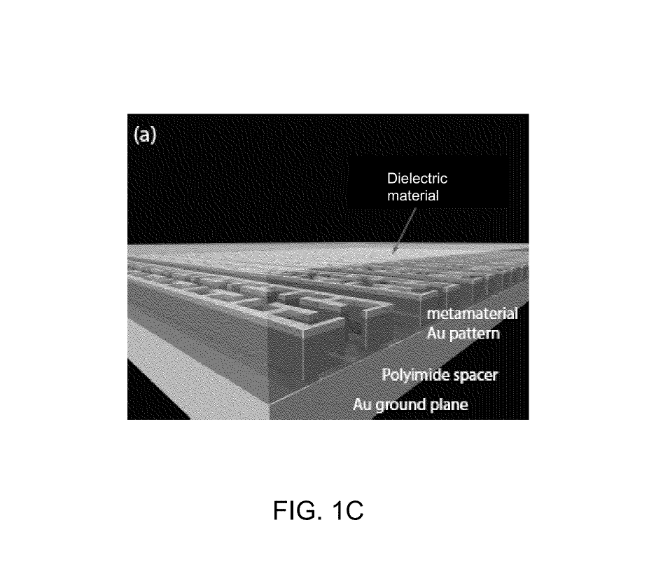

Metamaterial devices with environmentally responsive materials are disclosed herein. FIG. 1A illustrates an embodiment of a metamaterial perfect absorber (MMPA) 100 of the present disclosure. In some embodiments, the MMPA 100 includes a front layer 102, a back layer 104 and a dielectric layer 106.

The design of MMPA, which includes the estimation of the dimensions of each different layer can be carried out by means of numerical simulation tools. Generally, for THz application the thickness of the top and bottom metallic layers is generally not a concern since the dissipation of electro-magnetic (EM) energy is negligible and the metal behaves as a perfect mirror, generally as a rule of thumb a metal thickness of 100 nm is sufficient. At IR frequencies the metal is not ideal anymore and the simulations are used also to estimate the required metal thickness. The dielectric layer thickness is flexible over a certain range as the design of the patterned metal layer can be made such that it compensates for changes in the thickness. By way of a non-limiting example, FIG. 1B presents absorption response for dielectrics with different loss tangents and a variety of thicknesses. The robustness of the design extends to the material properties of the dielectric as well. MMPAs are designed to absorb light. When an electromagnetic wave with a certain frequency w is shown on an MMPA, the total energy budget can be summarized as T(ω)+R(ω)+A(ω)=1, where T is the transmissivity, R is the reflectivity, and A is the absorptivity. In the frame of EM absorbers, one goal is to maximize the absorption of energy A(ω)=1−T(−)−R(ω) by tailoring the transmission T(ω) and the reflection R(ω). In some embodiments, T(ω) and R(ω) are minimized for the totality of the energy to be dissipated or absorbed in the MMPA.

The front layer 102 of the MMPA 100 is geometrically patterned, as will be discussed below, in order to strongly couple to a uniformly incident electric field. By partnering the front patterned layer 102 with the back layer 104 a mechanism for coupling to the magnetic component of light is created. Tuning the geometry of the front layer 102 as well as the spacing between the front and back layers 102, 104 provides the controls to tune the effective material response parameters allowing for both impedance matching and strong absorption at a certain frequency. The minimization of T(ω) and R(ω) can be carried out through the design of the front layer 102 and the back layer 104, such as by, for example, through the selection of the geometry of the front layer 104, and the proper choice of the material for the dielectric layer 106.

Further, T(ω) and R(ω) are directly linked to, and thus depend on, the optical parameters of permittivity, 8(ω), and permeability, μ(ω), of an MMPA. The electric response ∈(ω) mainly depends on the shape of the resonator and on the thickness and the EM properties of the material used in the dielectric layer 106. The magnetic response μ(ω) results from the coupling between the front layer 102 and back layer 104. That means that such a coupling is strongly influenced by the type and the thickness of the material in the dielectric layer 106 between these two layers 102, 104. Parameters of particular importance for the dielectric layer 106 are the real part of the permittivity and the dielectric loss tangent tan δ, which is typically used to describe the energy lost in the material. For the majority of optical devices such as windows, mirrors, and filters the tan δ of the dielectric substrate is required to be negligible to avoid undesired system losses. This condition is hard to fulfill with the available dielectric materials and is doubly so when one considers resonant MM devices as the parameters governing loss increase near a resonance. In the case of MMPAs the electric and magnetic response can be tuned simultaneously by working on the dielectric medium only and large values of tan δ are not detrimental to the overall performances of the MMPA.

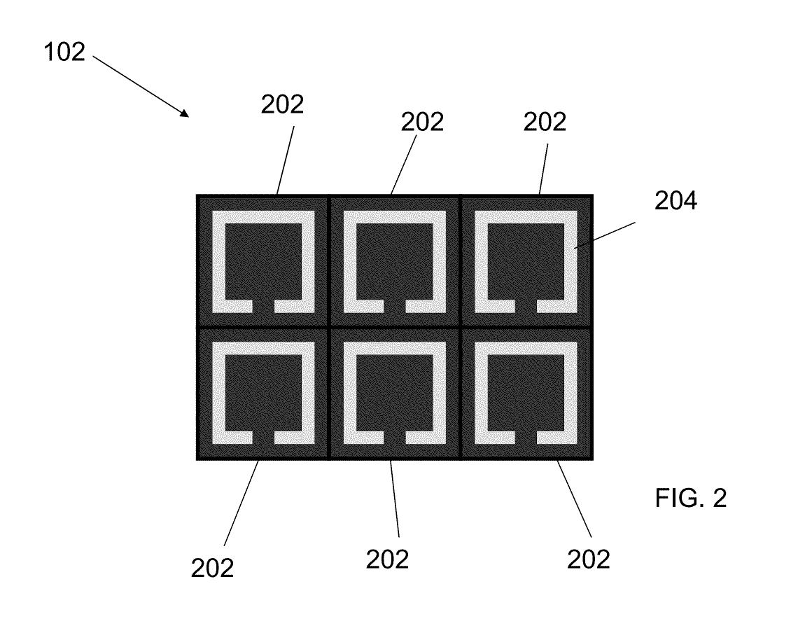

In some embodiments, the front layer 102 is a geometrically patterned metamaterial layer. Most metals are suitable for use in the front and back layers of the MMPA. The design is robust enough that differences in the conductivities of the metals can easily be accounted. In some embodiments, gold is used, due to its oxidation and corrosion resistance, with a thin (on the order of 10-20 nm adhesion layer) while copper is typically used for RF and microwave MM. A variety of metals are available for use in designs including but not limited to silver, titanium, aluminum, tungsten, and even superconducting materials have been shown to be viable choices in metamaterials. As shown in FIG. 2, the front layer 102 comprises a plurality of unit cells 202, each having a resonator 204. The front layer is thus formed as a 2D array of resonators spaced away from one another. The unit cells 202 can have identical resonators 204 or different resonators 204. In some embodiments, the resonators are arranged to form a periodic array. In some embodiments, the resonators are in an asymmetric arrangement.

Because the MMPA can be designed to work in any frequency band of interest the dimensions of the unit cell and the corresponding resonator are generally expressed in terms of the wavelength. In some embodiments, the values of MMPAs lattice constants a are between about λ/10 to about λ/4, where λ is the wavelength of the lowest resonant mode supported by the system. That is, if the MMPA is design to work at about 3 THz, the lattice constant ranges between about 10 μm and about 24 μm.

In some embodiments, the width of the metallic line that form the resonators is normally between a/10 and a/5 where a is the lattice constant. As for the lattice constant, also the range for the widths and lengths of the resonator span between λ/10 to λ/4. In some embodiments, the distance between the resonators corresponds to the lattice constant.

It should also be noted that although FIG. 2 illustrates square unit cells, unit cells 202 may have a non-square geometry, such as, for example, hexagonal, rectangular or similar geometry.

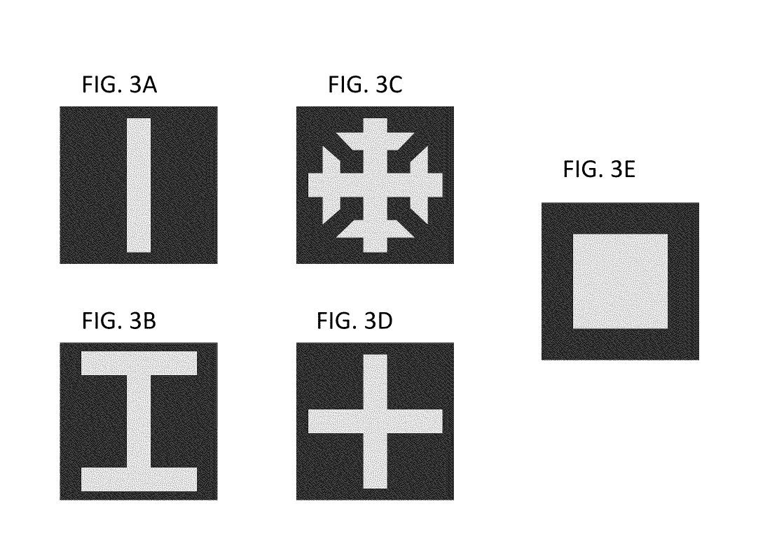

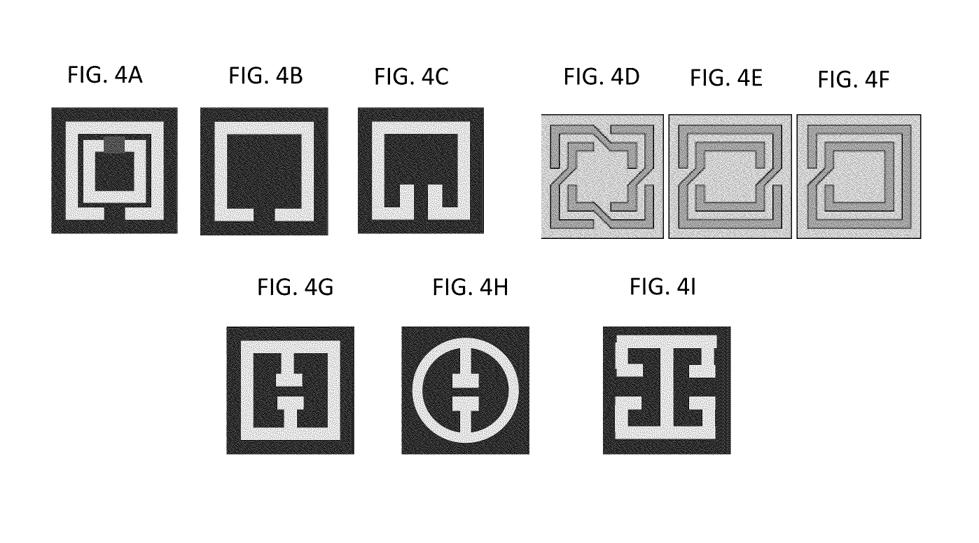

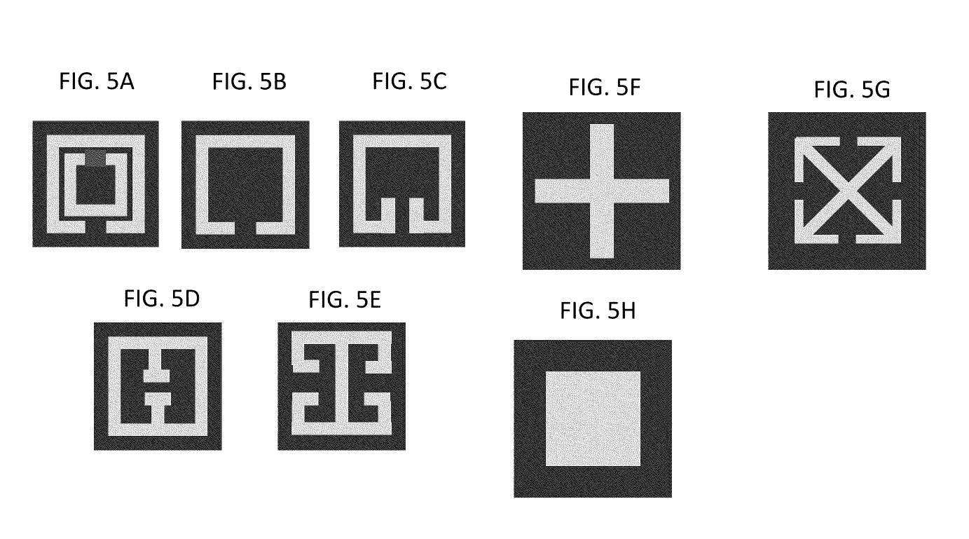

In some embodiments, the resonators 204 of the front layer 102 are of the electric resonator Class A type, such as a wire resonator (FIG. 3A and FIG. 3B), cross resonator (FIG. 3C and FIG. 3D), square resonator (FIG. 3E) or similar resonator. In some embodiments, the resonators 204 of the front layer 102 are of the magnetic resonator Class B type, such as a split ring resonator (FIG. 4A, FIG. 4B, FIG. 4C, FIG. 4D, FIG. 4E and FIG. 4F) or electric split resonator (FIG. 4G, FIG. 4H and FIG. 4I) or similar resonator. In some embodiments, the resonators 204 can be designed to be polarization sensitive. FIG. 5A, FIG. 5B, FIG. 5C, FIG. 5D, and FIG. 5E present non-limiting examples of polarization sensitive resonators. In some embodiments, the resonators 204 can be designed to be polarization insensitive (omnidirectional). FIG. 5F, FIG. 5G and FIG. 5H present non-limiting example of polarization insensitive resonators.

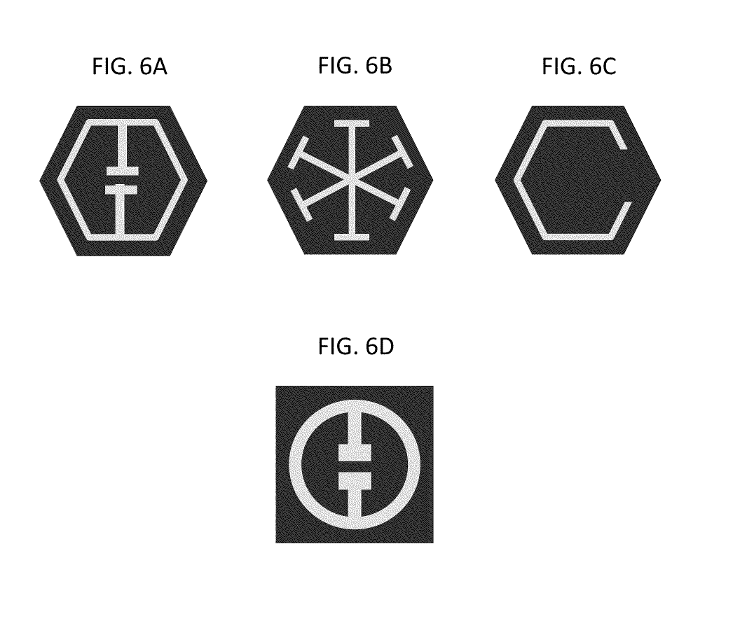

The unit cells 202 presented in FIGS. 3A-5H are of rectangular geometry, however, the unit cells 202 both can also have a non-rectangular geometry. By way of a non-limiting example, FIG. 6A, FIG. 6B and FIG. 6C, illustrate suitable hexagonal geometries for both unit cells 202 and resonators 204. By way of a non-limiting example, FIG. 6D illustrates a resonator having a suitable circular geometry.

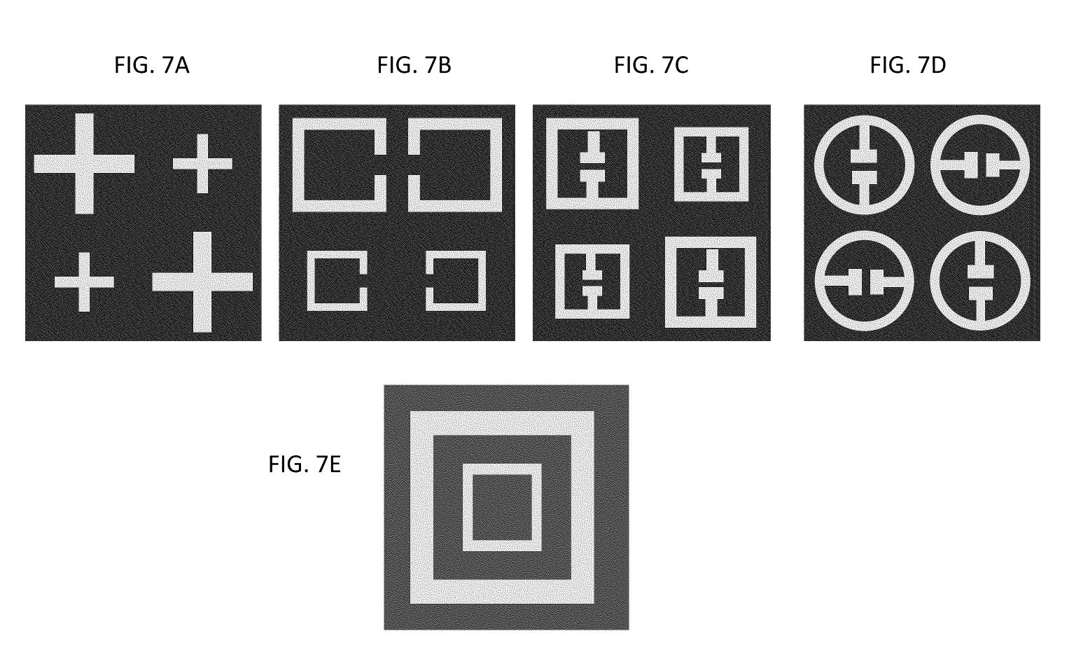

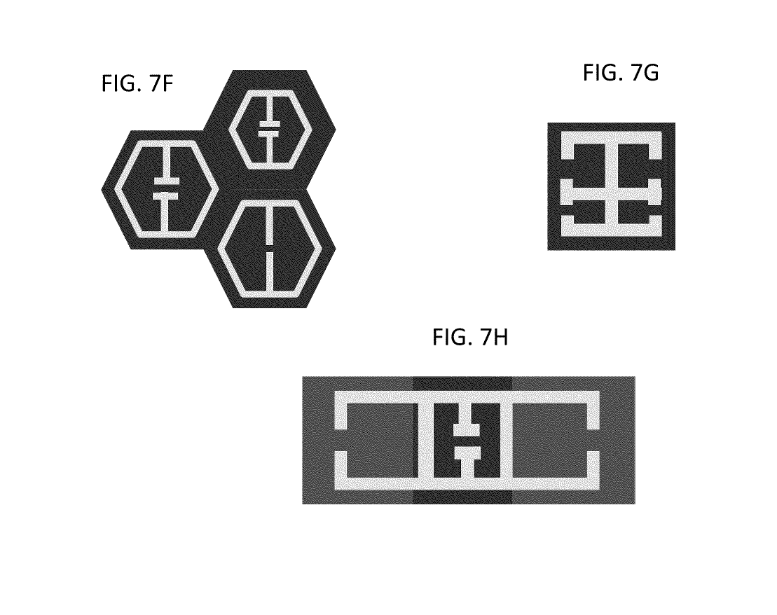

In some embodiments, the MMPA of the present disclosure is a multi-band absorber, absorbing in multiple distinct bands or in a broad band. Because resonators with different sizes resonate at different frequencies, by combining different-sized resonators in one unit cell, multiple resonances can appear in the absorption spectrum. If these absorption resonances are sufficiently close in frequency, then they can combine to form a broadband absorber. On the other hand, if these absorption resonances are further away from each other, then a multiple band absorber can be formed. In some embodiments, each unit cell 202 includes individual resonators 204 sized such that the MMPA of the present disclosure is a multi-band absorber. In some embodiment, the front layer 102 is designed such that two distinct resonant frequencies can be excited. In some embodiments, each unit cell 202 includes individual resonators 204 sized such that the MMPA of the present disclosure is a broadband absorber. FIG. 7A, FIG. 7B, FIG. 7C, FIG. 7D, and FIG. 7E illustrate suitable non-limiting embodiments of square unit cells having different-sized resonators for a multi-band MMPA. FIG. 7F illustrates suitable non-limiting embodiments of hexagonal unit cells having different-sized resonators for a multi-band MMPA. In some embodiments, the front layer 102 is made up of multiple layers of resonators, which share the same back layer 104.

In some embodiments, the resonators are designed such that different sections of a single resonator resonate at different frequencies to form a multi-band MMPA or a broadband MMPA. FIG. 7G and FIG. 7H illustrate suitable non-limiting embodiments of such resonator designs.

In some embodiments, the MMPA 100 of the present disclosure includes lumped elements to introduce tunability. Suitable examples of lumped elements include, but are not limited to, varactors, capacitors and inductors. Generally lumped elements are inserted at the gap between two metallic lines.

Referring back to FIG. 1A, in some embodiments, the back layer 104 of the MMPA 100 is a continuous conductive layer acting as a ground plane. In some embodiments, the back layer 104 is made of highly conductive materials, such as, for example, gold, silver, aluminum, copper or similar conductive materials. In some embodiments, the back layer 104 is a metamaterial layer having embodiments as described above in connection with the front layer 102. In embodiments where both the front layer 102 and the back layer 104 are metamaterial layers, the first and back layers 102, 104 may be the same or different. When the back layer is made of a continuous metallic film the transmission can be assumed to be zero. Whereas, when the back layer is an MM array the transmission becomes noticeable, but the condition for achieving near unity absorption are still possible.

As further shown to FIG. 1A, the front layer 102 and the back layer 104 are electrically separated from one another by a gap, into which the dielectric material can be inserted. The dielectric layer 106 may be sandwiched between the front layer 102 and the back layer 104. In some embodiments, the MMPA 100 is a multilayered structure with the dielectric layer 106, the front layer 102, the back layer 104 positioned at different levels. In some embodiments, the dielectric layer 106 may overlap with or encapsulate the front layer 102, the back layer 104, or both. In some embodiments, the dielectric layer 106 is positioned in-between the front layer 102 and the back layer 104, such that there is no overlap between the layers. In other words, in some embodiments, the dielectric material is fully contained between the inner surfaces of the front layer 102 and the back layer 104, with the one surface of the dielectric layer 106 being flush with the inner surface of the front layer 102 and the opposite surface of the dielectric layer 106 being flush with the inner surface of the back layer.

In reference to FIG. 1C, in some embodiments, the dielectric layer 106 may include multiple dielectric materials. In some embodiments, a first type of dielectric material (supporting dielectric material) may be placed between the front layer 102 and the back layer 104. The refractive index of the supporting dielectric material may be selected to tailor the electromagnetic response of the metamaterial front layer 102. Gaps or trenches may be created in the supporting dielectric material by removing supporting dielectric material that is not under the metal of the front metamaterial layer 102, as shown in FIG. 1C. In other words, the supporting dielectric layer may be patterned to resemble the pattern of the metamaterial front layer 102. These gaps or trenches may be filled with another type of the dielectric material, referred herein as a functional dielectric material. In some embodiments, the trenches may be filled with a liquid crystal material, as described below. In this manner, the liquid crystal material can be contained within the MMPA, and the amount of liquid crystal material positioned between the different bias lines may be optimized. In some embodiments, where the dielectric material is selected from a pyroelectric material or a phase change material, the reduction in the supporting dielectric material may decrease the thermal mass of the layer which could allow for the device to be modulated at higher frequencies. In some embodiments, the dielectric layer 106 may be of a single type material, but the trenches may still be added.

In some embodiments, the dielectric material may be used to encapsulate the MMPA 100, in whole or in part. Such coverage can be used to protect against physical damage to the MMPA 100 or from exposure of the MMPA 100 to harmful materials that may corrode or oxidize the front layer or the back layer. Damage to these layers may alter the response of the MMPA 100. Such encapsulation may also be used to adjust or modify the working frequency of the metamaterial front layer 102. In some embodiments, the dielectric layer 106 or the functional dielectric layer 106 comprises a pyroelectric material. Suitable pyroelectric materials include, but are not limited to, Poly Vinylidene Fluoride (PVDF), Tri Glycerin Sulphate (TGS), PST (Lead Stannic Titanate), LiTaO₃ (Lithium Tantalate), LiNbO₃ (Lithium Niobate), PZT (Lead Zirconate Titanate), Deuterated triglycine sulfate (DTGS), Barium Strontium Titanate (BST) or similar materials.

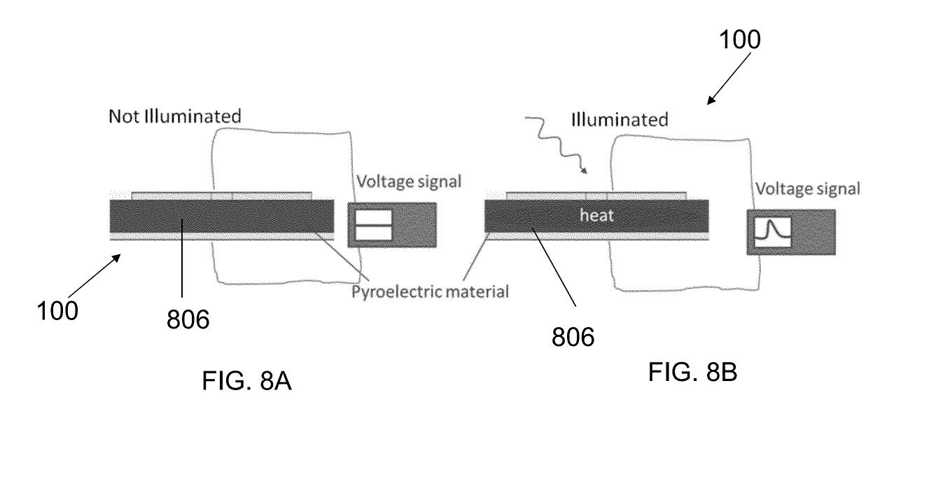

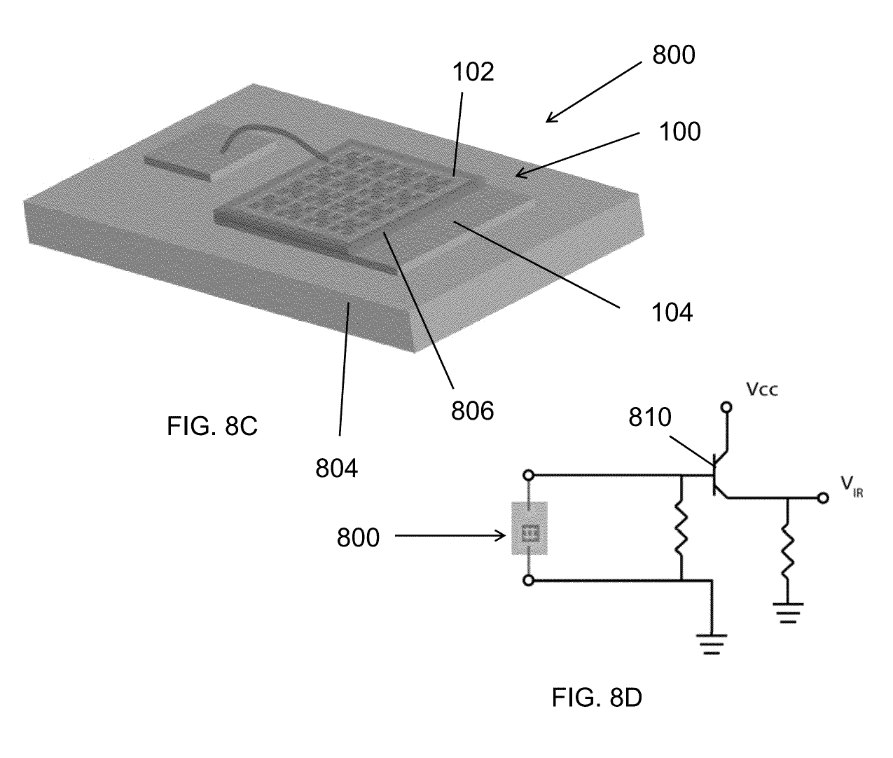

Pyroelectric materials are materials capable of generating a voltage in response to a change in temperature, such as when the material is heated or cooled. Due to this property of the pyroelectric materials, during the electromagnetic wave absorption process in the MMPA, a temporary electric voltage is produced between the two opposite ends of the pyroelectric layer. When the MMPA is not illuminated the voltage signal is flat, whereas when light impinges on the top layer of the MMPA it converts the EM energy into heat. In reference to FIG. 8A, when an MMPA 100 with the dielectric layer 106 comprising a pyroelectric material 806 is not illuminated, there is no voltage generated in the pyroelectric material. However, as shown in FIG. 8B, when the pyroelectric material 806 is illuminated, a voltage is generated between the two opposite ends of the pyroelectric material due to the increase in temperature of the pyroelectric material. The heat, which is localized inside the dielectric layer generates a charge distribution at the two opposite ends of the pyroelectric slab resulting is a non-zero voltage signal on the voltmeter. The electric charge generated upon heating can then be collected by the front layer 102 and the back layer 104 and can be used to detect the presence or the absence of light.

MMPAs of the present disclosure with one or more pyroelectric materials can be used in a number of different applications. In general pyroelectric detectors have a number of important characteristics (low cost, low power, wide operating range of temperature etc) which make them ideal for applications where the cost, power and cooling requirements of photoconductive or photovoltaic detectors are impractical and the very highest radiometric performance is not required. In some embodiments, MMPAs with pyroelectric materials can be used in energy-sensitive devices, in particular infrared and THz detectors.

In some embodiments, the light incident on the detector may be modulated as the pyroelectric response is based on a change in temperature and vanishes at thermal equilibrium. This typically done by optically chopping (rotating shutter wheel with alternating open and closed regions) or if actively illuminating a scene modulating the light source directly. Signal noise can be reduced by using a lock-in amplifier which captures signals only at the modulation frequency. A preamplifier may also be used if the signal is weak.

In reference to FIG. 8C, a pyroelectric detector 800 of the present disclosure may include one or more MMPAs 100 of the present disclosure on a substrate 804. The MMPAs have a front metamaterial layer 102, a back layer 104, and a pyroelectric material layer 806 between the front and the back layers 102, 104. The MMPAs may be connected to a meter, such as a voltage meter, which is configured to measure a voltage generated in the pyroelectric material layer 806 of the MMPA 100 when the pyroelectric material layer 106 is illuminated.

FIG. 8D illustrates an embodiment of a circuit diagram for a voltage mode system that may be employed with the pyroelectric detectors 800 of the present disclosure. In some embodiments, the circuit may employ an amplifier 810, such as a junction gate field-effect transistor (JFET) amplifier. A DC voltage (V_{CC}) may be applied to the source connection of the amplifier 810, and the voltage generated by the pyroelectric material 806 of the pyroelectric detector 800 may connected to the amplifier gate. The final output voltage (V_{IR}) is the drain of the amplifier. The V_{IR} may be measured by variety of methods known in the art.

Traditional pyroelectric detectors typically include a broadband absorber coating on the top of the device. The broadband absorber coating absorbs light and converts the absorbed light to heat within the broad band absorber coating. The heat then needs to be transferred from the broadband absorber coating to the pyroelectric layer, so the voltage is generated in the pyroelectric material due to increase in temperature of the pyroelectric material. On the other hand, in the pyroelectric detectors of the present disclosure, the light is absorbed and converted into heat directly in the pyroelectric layer, as shown in FIG. 8B. This may lead to improved performance and sensitivity when compared to the traditional design because the pyroelectric detectors of the present disclosure may be more efficient in heating the pyroelectric layer, resulting in a higher rate of temperature change in the pyroelectric material and thus a greater output signal. Due to the improved performance and sensitivity, the pyroelectric materials of the present disclosure may be able to detect light sources with lower powers compared to the non-metamaterial detectors.

In some embodiments, pyroelectric material based MMPAs of the present disclosure can be configured to absorb all incident light over a given frequency band, such as THz frequency band or IR frequency band. Pyroelectric based MMPA sensors offer a number of advantages over conventional pyroelectric sensors. For example, pyroelectric based MMPA sensors are more advantageous for those applications where very narrow bandwidth response is required. Conventional pyroelectric detectors are intrinsically broad band and their bandwidth depends on the properties of the pyroelectric compound. There is a pletora of applications where small inexpensive and narrowband chemical sensors are necessary like detection and identification of toxic industrial chemicals and chemical agents, or for Civilian Support Teams and Fire Departments that have a critical need for a rugged, inexpensive sensor that can be transported to the field to test for possible contamination by CW agents.

In some embodiments, the temperature shift in the pyroelectirc material due to the absorbed light can be measured as a voltage response from the pyroelectric material. In some embodiments, taking advantage of the ability of pyroelectric materials to generate heat from an applied voltage and pursuant to Kirchhoffs law of thermal radiation, the defined absorption band of an MMPA with a pyroelectic material can also have a corresponding well defined emissivity. In some embodiments, an MMPA with a pyroelectric material can be used as an IR blackbody source with frequency specific emission.

In FIG. 8A and FIG. 8B, the pyroelectric MMPA is used as absorber, but due to the properties of pyroelectric materials, heat can be generated when biasing the pyroelectric material. This allows the MMPA to work as an emitter rather then an absorber. The pyroelectric material without the MM will act as a broad band black body source, while combining it with a MMPA provides the ability to emit at a specific frequency.

There are a number of different categories of anticipated end-users for MMPAs with pyroelectric materials, including consumer/commercial products (compare to low cost visible camera sensors and their wide spread inclusion in modern electronics), industrial applications such as process and quality control, and military imaging systems. Thermal imaging systems have proved invaluable for firefighters and rescue personnel. Because of their intrinsic narrow band response pyroelectric based MMPAs can also be used for applications such as the detection and identification of toxic industrial chemicals and chemical agents. A rugged, inexpensive chemical sensor can benefit the manufacturing community by providing inexpensive monitoring of chemical processes. Also, first responders such as Civilian Support Teams and Fire Departments have a critical need for a rugged, inexpensive sensor that can be transported to the field to test for possible contamination by hazardous agents.

In some embodiments, the dielectric layer 106 or the functional dielectric layer 106 comprises a phase change material. Phase change materials are materials that can be reversibly switched between crystal and amorphous phases when properly biased. These phases have different values of permittivity and their use in the dielectric layer 1060R the functional dielectric layer in the MMPA 100 results in a tunable MMPA.

Suitable phase change materials include, Vanadium Oxide, Germanium Antimony Tellurium (Ge₂Sb₂Te₅), Germanium Arsenic Gallium Selenium (Ge₃₀As₈Ga2Se₆₀), Germanium Gallium Selenium (Ge₃₅Ga₅Se₆₀), Germanium Arsenic Sulfur (Ge₁₀As₂₀S₆₀), Arsenic Sulfide (As₂S₃), Gallium Lanthanum Sulfide (GaLaS), Silver Indium Antimony Tellurium (AgInSbTe), and combinations thereof.

Liquid crystal materials (LCs) are also a suitable example of a phase change material. Liquid crystal materials can be used to introduce tunability in the MMPA in a similar fashion as phase change materials. Tuning can be obtained by changing the orientation of the LC droplets, which can be embedded in between the front and back layers 102, 104 of the MMPA 100 of the present disclosure, through a voltage bias. Suitable liquid crystal materials include, but are not limited to, PP5CN (5CB), PP4NCS, PPP(3,5F)40NCS, PTP4NCS, PTP40NCS, PTP5O1, BL037, PCH-5 and combinations thereof.

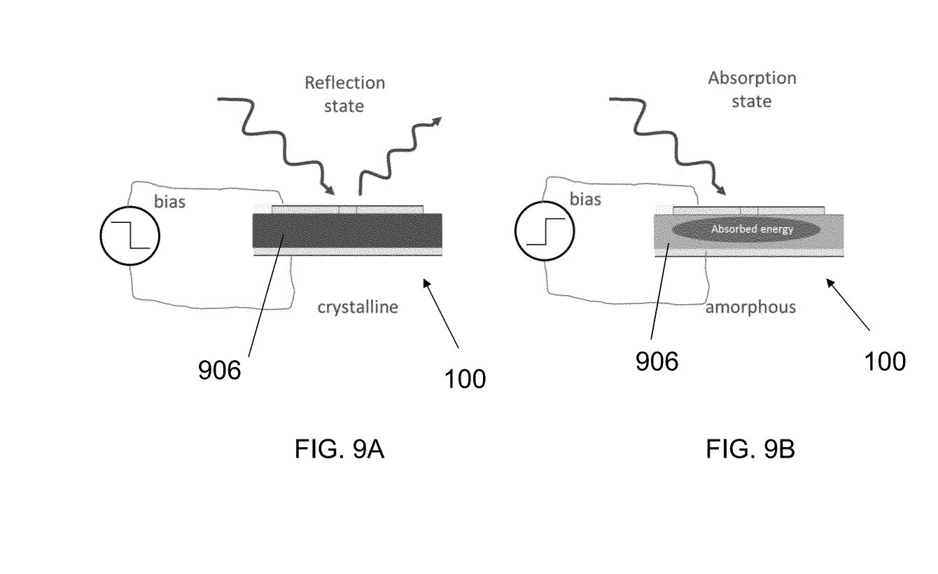

FIG. 9A and FIG. 9B illustrate an embodiment light modulation mechanism. A bias voltage induces the phase of the phase change material 906 in the dielectric layer 106 to transition between crystalline (FIG. 9A) and amorphous (FIG. 9B). Referring to FIG. 9A, when the phase change material 906 is in the crystalline phase, the light shown on the MMPA 100 is totally reflected, that is, the MMPA 100 is in a reflection state. On the other hand, as shown in FIG. 9B, under a different biasing condition, the phase change material 906 in the dielectric layer 106 is switched into the amorphous phase. This change induces a different EM response of the MMPA resulting in high absorption of the EM energy, that is, the MMPA 100 is in an absorption state.

As a modulator the front layer 102 and the back layer 104 can play two different roles simultaneously in this process. One role is to be an active part of the MMPA 100 by interacting with each other and thus contributing to the electric and magnetic response when irradiated with light. The other role is to act as biasing pad. This represents an important advantage since it provides an ideal setup for the design of a tunable device.

The claimed advantage arises from the fact that in order to change the properties of a phase change material a voltage bias needs to be applied between two opposite face of the material through two metallic pads. In the MMPA, the phase change material is sandwiched between two metallic layers located at the two opposite ends. This allows switching of the phase change material with no need of other extra metallic pads. The above is an advantage in terms of practicality of the fabrication process because there is no need to add extra metallic line on top of the MMPA surface to provide the correct biasing for the switching. Basically, the tuning is achieved at zero additional costs. Also there is clear intrinsic advantage over MM with phase change materials in the gap since in the latter case it would require more accurate fabrication techniques to precisely place the material inside the gap. By way of a non-limiting example, for THz applications the gap can be smaller than about 10 μm, while for IR applications the gap size can be hundreds of nanometers, which can be challenging from a device fabrication point of view.

In some embodiments, MMPAs of the present disclosure comprising one or more phase change materials is used as a basic building block of a spatial light modulator (SLM).

SLMs are devices that impose some form of spatially varying modulation on a beam of light. SLMs exist in two configurations, transmission and reflection. In the transmission configuration, the transmitted component of the light intensity is modulated, whereas in the reflection configuration, the reflected portion is modulated. SLMs are widely used in a number of technologies that see everyday use such as projectors which make use of an array of micro mirrors that can be actuated to direct light and liquid crystal displays. Other applications are holographic data storage, holographic display technology, and holographic optical tweezers. Another growing field that is directly related to imaging and sensing where SLM plays a key role is single pixel imaging via compressive sensing. For many of the above applications the frame rate (the speed at which the SLM can update the modulation pattern) represents a limiting factor. Typical values range between hundreds of Hertz to few kHz. For real time single pixel applications frame rates of the order of MHz are necessary.

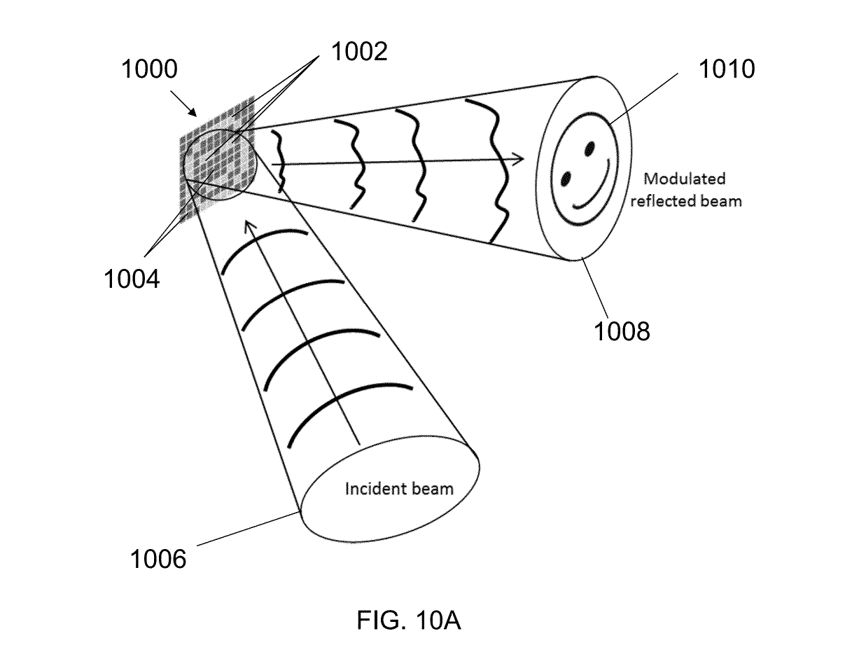

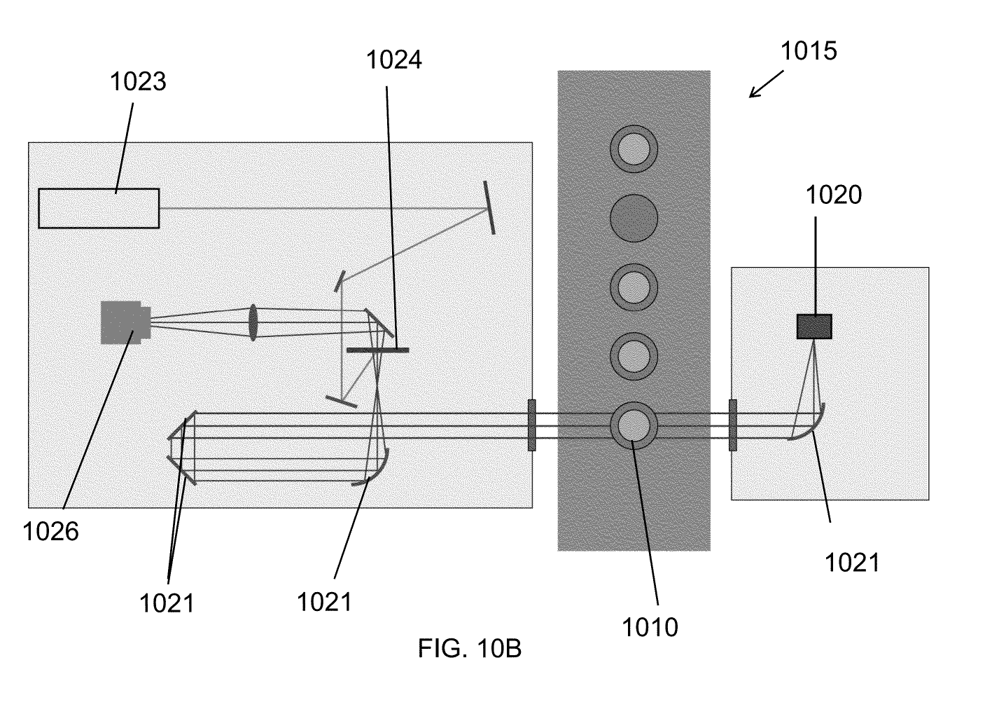

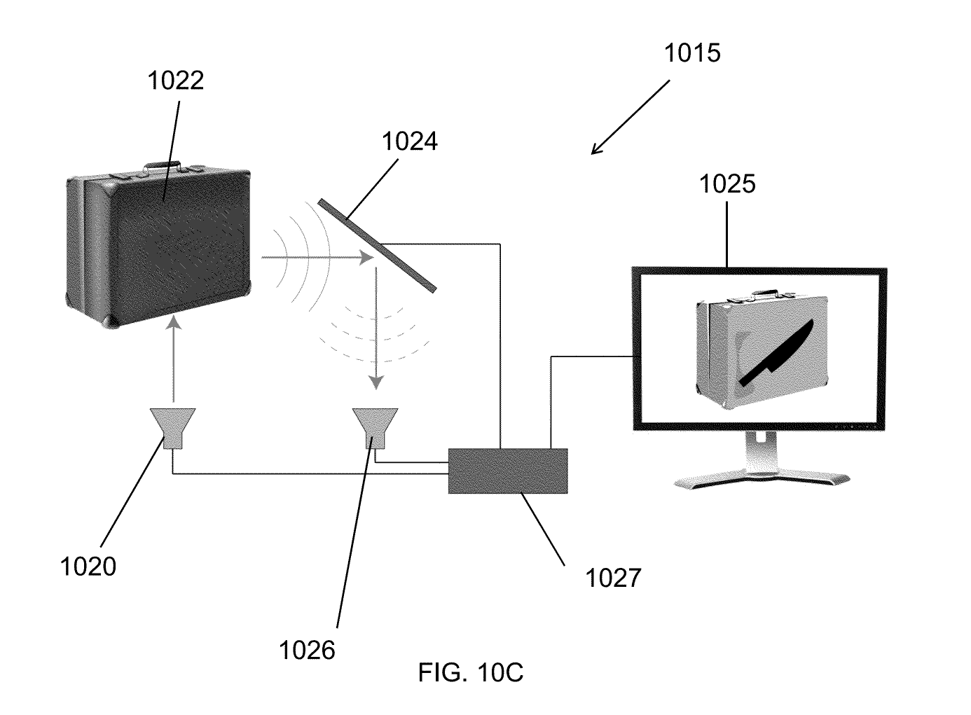

In some embodiments, MMPAs of the present disclosure comprising one or more phase change materials can be used for a reflecting SLM. Typically SLMs are formed by an array of pixels, when light shines on the array each pixel can either reflect or absorb the light. A SLM can be built by arraying together MMPA pixels embedded with phase change materials and controlling the absorption/reflection of each pixel electrically through biasing, as explained above in reference to FIG. 9A and FIG. 9B. In some embodiments, the image formed after the light is reflected off the SLM is created as follows. Where the light beam hits a pixel where the phase change material is in the crystalline state, there will be a peak in the reflected intensity because the phase change material reflects light in the crystalline state. On the other hand, where the beam hits a pixel where the phase change material has been switched into the amorphous phase, there will be a minimum in the reflected intensity, because the phase change material absorbs light in the amorphous state. In some embodiments, the result of this process can be an image made of high intensity and low intensity pixels. This is illustrated in FIG. 10A, which shows a spatial light modulator 1000 including pixels 1002 (light pixels) with the phase change material in the amorphous state to absorb the portion of the incident intensity and pixels 1004 (dark pixels) with the phase change material in the crystalline state to reflect the portion of the incident intensity. The SLM 1000 modulates an incident beam 1006 to result in a smiley face absorption pattern 1010 in the modulated reflected beam 1008.

FIG. 10B and FIG. 10C present an embodiment of an imaging system 1015 for non-destructive evaluation of an object. As illustrated, the system is a single pixel imaging system but multiple pixel systems may also be provided. The light modulators of the present disclosure may be used for compressive imaging where one can image a scene by using a single pixel camera instead of a focal planar array. In some embodiments, THZ radiation may be employed. THz radiation is capable of penetrating objects that other wavelengths like optics and infrared cannot. Moreover, THz radiation can be used to detect metals and drugs hidden in boxes or backpacks. As shown in FIG. 10C, a THz source 1020 may be used to illuminate an object to be imaged 1022. The light scattered from the object 1022 may be directed, using a plurality of various mirrors 1021, to a MMPA based spatial modulator 1024. The MMPA based spatial modulator 1024 may be used as a coded aperture mask which blocks certain portions of light to create a series of known patterns. In some embodiments the series of mask patterns may consist of mathematically described sets, such as, for example, a Hadamard matrix. In some embodiments, an assortment of random masks may be used. The modulated, coded signal is cast upon a THZ detector 1026, such as a single pixel camera, that collects the amplitude information. The pixel configuration may be varied and multiple measurements may be made where each uses a unique arrangement of on and off pixels, also known as the masks. The reconstruction process may use the measured signal and the corresponding mask configuration that created it. The final image may then be elaborated totally at the software level 1027 through compressive sensing algorithms, and presented to the user on a screen 1025. In some embodiments of the THz imaging system, an optical LED 1023 may be used to generate the masks by illumining and photodoping a semiconductor wafer. In this way the LED 1023 may act as the excitation source used to tune the phase change material of the spatial light modulator 1024. In other configurations, an electrical connection can be used to induce the phase change in the phase change materials. It should of course be understood that while the system 1015 has been described in connection with detecting light in the THz range, the system 1015 may be used to detect other radiation of other wavelengths.

One benefit of using MMPA of the present disclosure including one or more phase change materials for SLMs is in their intrinsic narrow band response, which is a great advantage in those applications where imaging needs to be carried out at a single frequency.

In those imaging application where it is required, a narrowband response of the SLM will allow to extrapolate information about the physical properties of the object under investigations at that specific frequencies of interest and discard all that are not of interests. Current SLMs are made with LCs or micro mirror devices (DMD), which are essentially broad band. When light impinges on it and reflects back all the spectral content is more or less preserved. For example, if white light, which includes the contribution from all the rainbow colors, is shown on a DMD SLM, the reflected light is still white, whereas if the SLM has narrow band pixels it is possible to reflect only a single color of the spectrum. In ordinary SLMs color discriminations can be done by combining color filters by this affects the energy throughput. In narrow band applications this can be a benefit since it doesn't require extra color filter after the light is reflected off the SLM.

Also, by changing the geometry of the front layer 102 it is possible to provide a multiband capability to the SLM, as described above. Another potential benefit of using MMPA of the present disclosure including one or more phase change materials is in their property of scalability, which allows achieving the same EM absorption characteristics at different frequencies. In contrast, existing technology, such as LC and DMD, are not scalable. These technologies were originally made to work at optics and IR but as any other material they also have an electromagnetic response in frequency bands like THz and microwaves, in each band the mechanism of absorption is different. In the MMPAs, the property of scalability provides a way to have the same mechanism of absorption at different frequencies. This is achieved simply by scaling the dimensions of the resonators. In some embodiments, this property can be used to form an SLM for Terahertz, millimeter waves and microwave frequencies, which would provide great benefit in the field of radio communications, imaging, homeland security, etc, because currently all the SLM available on the market, are based on LC and MEMS technology and can only work in the visible and IR range.

In some embodiments, the dielectric layer 106 includes one or more ferroelectric, magnetoelectric, piezoelectric, semiconductors, superconductors. MMPAs with such materials can be used in applications described in connection with MMPAs with one or more phase change materials or liquid crystal materials. In some embodiments, the dielectric layer 106 includes semiconductors and superconductors. MMPAs with such materials can be used in applications described in connection with MMPAs with one or more pyroelectric materials.

The technologies outlined above offer the potential for the creation of a wide array of devices at THz and IR frequencies that incorporate tunable frequency and amplitude behavior as well as a new class of imaging systems and detectors. The THz detectors based on MMPAs of the present disclosure have multiple advantages that can be used for reducing the operating cost of the device specifically through the elimination of expensive consumables such as the cryogens liquid nitrogen and liquid helium and though improved power efficiency. A room temperature MMPA THz detector offers direct and indirect advantages for reducing the energy consumption of a research laboratory. The metamaterial perfect absorber array located in each pixel requires no operating power. Indeed the only power needed by the detector is for the electronics used to measure the output from the pyroelectric. Because of the low power requirements, in some embodiments, THz detectors and imagers of the present disclosure may be light-weight and handheld.

The detection aspect is also viable at IR frequencies well outside of the THz band, offering many of the same benefits as the THz implementation such as the size, weight, and power. New FPA imaging systems could be created that do not rely on cryogenics and offering improved sensitivity when compared to the current class of IR detectors. Over certain IR bands existing detectors have reduced performance due in part to the lack of suitable materials the MMPA pyroelectric detector would not be required to sacrifice important performance related metrics as they are not material limited in their potential operational frequency range.

Metamaterial perfect absorber functioning as a thermal detector has several key advantages. Outside of the operational frequency (ω₀), the reflectivity is quite high, with values well over 80%. Thus this natural narrowband metamaterial resonance is a salient feature for thermal detectors as it is naturally apodizing, in the sense that radiation outside of the range of interest is reflected form entering the device. Other “broad-band” thermal detectors, e.g. liquid helium silicon bolometer, utilize other elements to perform this same function, thus adding complexity, weight and size. Another advantageous property of the metamaterial imaging pixel is the narrow band resonant behavior. In order to achieve sufficient signal-to-noise for any given detector, especially in the case of thermal detectors, it is necessary to restrict bandwidth, especially in regions of the electromagnetic spectrum where variations in the background may vary significantly, such as the THz. Further, the option to perform hyperspectral imaging also requires narrow bandwidth to resolve the narrow lines that materials of interest may yield. The highly resonant nature of the metamaterial perfect absorber yields a high absorption coefficient. This low thermal mass is ideal for response time, as well as necessary to achieve a compact, lightweight design. Since the elements which constitute our bolometer are sub-wavelength, metamaterials can inherently image at the diffraction limit. In some embodiments, the device may include only a single unit cell in the propagation direction, (with a thickness significantly smaller than the wavelength λ/80), yet achieves an experimental absorbance of about 95%.

Accordingly, MMPAs of the present disclosure may be used to develop hand held THz detectors and cameras, THz security and screening portals, low cost room temperature THz detectors, THz medical imaging systems, IR bolometers, handheld IR thermal imagers, IR detectors, frequency tunable optics components for THz and IR, such as, mirrors, windows, modulators, beam splitters, spatial light modulators of THz and IR, and devices for energy harvesting from IR sources, such as waste heat and solar heat converters.

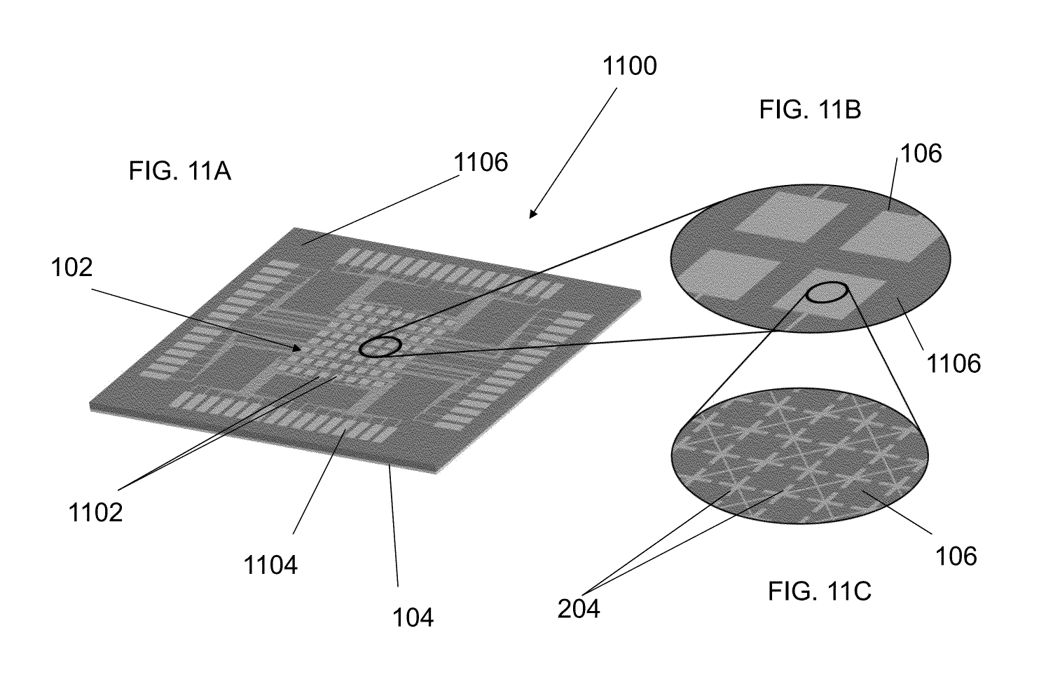

FIG. 11A illustrates a top view of an embodiment of a multi-pixel MMPA-based device 1100, such as detector or SLM device. In some embodiments, the top layer 102 includes a plurality of pixels 1102. FIG. 11A illustrates an embodiment with a square 8×8 pixel array, however, the number of the shape of the array and the number of pixels in the array may vary. FIG. 11B illustrates an enhanced view of a region of several pixels 1102 of the device of FIG. 11A. As further illustrated in FIG. 11C, each pixel 1102 comprises an array of resonators 204, i.e. metamaterial pattern. Any resonator type can be used in individual pixels, independently of the resonator type used in other pixels. Referring back to FIG. 11A, the MMPA-based device 1100 also includes a plurality of electrodes 1104 connected to the plurality of pixels 1102 to be used to readout a signal from the pixel or to provide the dynamic control of the metamaterial pixel. The MMPA-based device 1100 further includes the back layer 104 and the dielectric layer 106. In some embodiments, the dielectric layer 106 can be patterned such that the dielectric material (pyroelectric material, phase change material, etc.) is only under the pixel 1102, as shown in FIG. 11B. In some embodiments, the MMPA-based device 1100 may also include an isolation layer 1106 between the pixels 1102.

The methods and materials of the present disclosure are described in the following Examples, which are set forth to aid in the understanding of the disclosure, and should not be construed to limit in any way the scope of the disclosure as defined in the claims which follow thereafter. The following examples are put forth so as to provide those of ordinary skill in the art with a complete disclosure and description of how to make and use the embodiments of the present disclosure, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for.

### EXAMPLES

### Example 1

### Liquid Crystal Tunable Terahertz Metamaterial Perfect Absorber

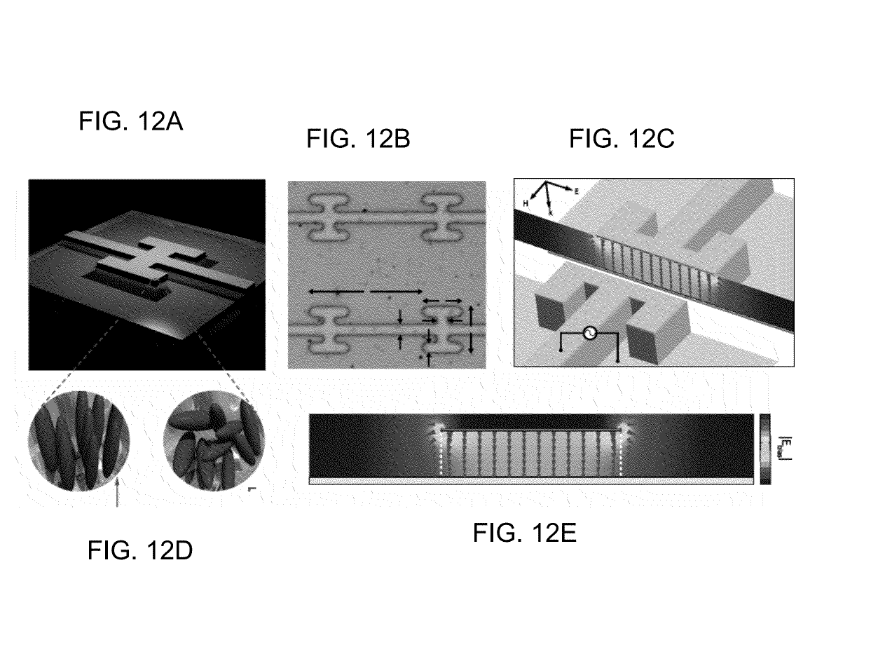

An optical microscope image of the fabricated device is shown in FIG. 12B with a single unit cell having the dimensions as labeled. Electric ring resonators (ERRs) were fabricated to form a square array with 50 μm lattice spacing. Each unit cell is connected to its neighbors via horizontal metallic wires (4.5 μm width) and the entire array is connected to bias pads lying at the perimeter of the device. A 200 nm Au/Ti continuous metal ground plane was E-beam deposited on top of a supporting silicon (Si) substrate. A 5.5 μm thick liquid polyimide (PI-5878G, HD Microsystems™) dielectric layer was spin coated on top. Ultraviolet (UV) photolithography is used to pattern photoresist which was used for final deposition of 200 nm Au/Ti to create the ERR layer. The ERR structures were used to serve as a hard mask for inductively coupled plasma and reactive ion etching in order to remove all polyimide not directly underneath the metamaterial layer.

The liquid crystal 4′-n-pentyl-4-cyanobiphenyl (5CB) is deposited on top of the metamaterial array and completely fills in and encapsulates the polyimide/metal structure. 5CB possesses a nematic LC phase at room temperature with large birefringence (nₑ−nₒ=Δn) at THz frequencies ranging between 0.11 to 0.21, where the refractive index can be switched between its ordinary no and extraordinary ne value in the presence of an electric field. A schematic shown in FIG. 12A and FIG. 12D illustrate the mechanism by which the LC is tuned. A potential is applied between the ERR and ground plane which orients the LC along field lines (see FIG. 12C). The polyimide is required for structural support however it also plays another role in the design described herein. Most liquid crystals have large interactions with boundaries which may inhibit any possible response to an applied electric field thus causing threshold phenomena, an effect called the Freedericksz transition. The configuration described herein permits LC near the surface of the polyimide to be orientated with electric field lines. This may also facilitate a smooth tuning of the refractive index as a function of applied electric field.

The frequency dependent reflection [R(ω)] was characterized at an incident angle of 20 degrees from 2.0 to 3.5 THz using a Fourier-transform infrared spectrometer, liquid helium-cooled Si bolometer detector, and a germanium coated 6 μm mylar beam splitter. The measured reflection spectra are normalized with respect to a gold mirror and calculation of the frequency dependent absorption as A(ω)=1−R(ω) since the transmitted intensity was zero due to the metal ground plane. The measurements were performed with the THz electric field perpendicular to the metal connecting wires, as depicted in FIG. 12C. The LC molecules can be aligned by applying a square-wave potential between the ERR metal layer and the ground plane at various modulation frequencies (f_{mod}). The square-wave was centered about zero and has peak-to-peak voltage equal to twice the peak bias voltage (V_{bias}). Using a modulated bias can prevent free carrier build-up at the electrode metal interface which can occur for DC applied potentials.

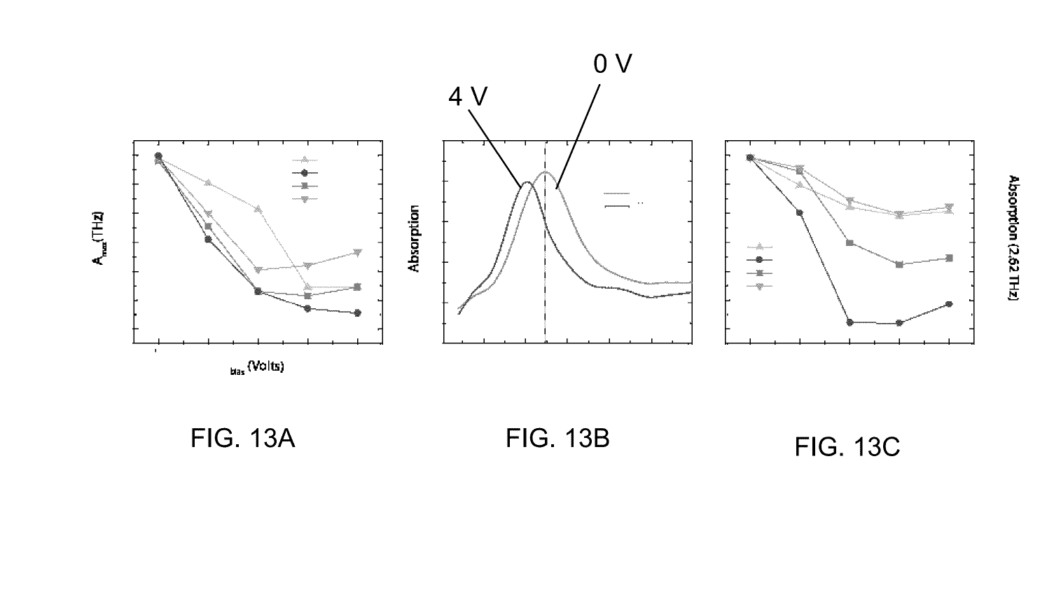

The absorption was characterized for a number of different bias values and modulation frequencies. FIG. 13A shows the frequency location of the absorption maximum (Aₘₐₓ) as a function of V bias for modulation frequencies of 373 Hz, 1 kHz, 10 kHz, and 100 kHz. The general trend is that as the applied voltage is increased, the metamaterial absorption shifts to lower frequencies. For f_{mod}=373 Hz and 1 kHz the change is monotonic for increasing potential, but deviations were found from this for 10 kHz and 100 kHz. As can be observed in FIG. 13A, the greatest frequency shift occurred for f_{mod}=1 kHz. FIG. 13B plots the frequency dependent absorption A(ω) for 0 V (blue curve) and 4 V (red curve) at f_{mod}=1 kHz. With no applied bias, a reasonable absorption of 85% at 2.62 THz was achieved, a full width half max (FWHM) of 600 GHz and the spectrum is otherwise featureless. At V_{bias}=4 V, the resonant absorptive feature shifts to 2.5 THz, lowers to a peak value of 80% and narrows slightly with a FWHM of 420 GHz. This represented a shift in the peak of the absorption by 4.6% in frequency.

Although tuning of the absorption peak is relatively small, (less than 5%), in many applications amplitude modulation only over a narrow band may be desired. For example, operating at a fixed frequency of ω₀=2.62 THz, i.e. the peak absorption of the unbiased case is plotted in FIG. 13B. Plots of A(ω₀) as a function of V_{bias} for various modulation frequencies is presented in FIG. 13C. Generally, it is observed that the absorption level dropped as a function of increasing voltage bias for all modulation frequencies investigated, which seems to saturate near 3-4 volts of applied bias. The greatest change in A(ω₀) occurs for 1 kHz bias modulation, as shown by the red curve in FIG. 13C in accord with the results presented in FIG. 13A. The LC 5CB thus provides electronic means of both frequency and amplitude tuning of the absorption peak of metamaterial perfect absorbers and realizes an amplitude tuning of over 30% at w=2.62 THz.

Full wave 3D electromagnetic simulations were performed. The Au/Ti metal layers were modeled as a lossy metal with a frequency independent conductivity of σ=4.56×10⁷ S/m, and the polyimide layer with a relative permittivity of ~∈_{poly}=∈₁+i∈₂=2.88+i0.09. The complex refractive index of 5CB, (with zero applied bias) was modeled as a lossy dielectric with ~n5CB=n5CB+iκ5CB=1.82+i0.14. As mentioned, the LC encapsulates the metamaterial array and thus a 2 μm thick layer was modeled on top of the ERR. It is assumed that any LC not lying in-between the ERR and ground plane is unaltered by the applied bias, as shown in FIG. 12C and FIG. 12E. The THz birefringent properties of 5CB have been characterized as an increase in the real part of the refractive index (n_{5CB}), (for increasing applied bias), between the ordinary and extraordinary states. However, it has been demonstrated that there is little difference in the imaginary component (κ_{5CB}) above 1.2 THz. In simulation, only n_{5CB} was thus modified as a function of Vbias and the imaginary refractive index constant was kept at a value of κ_{5CB}=0.14.

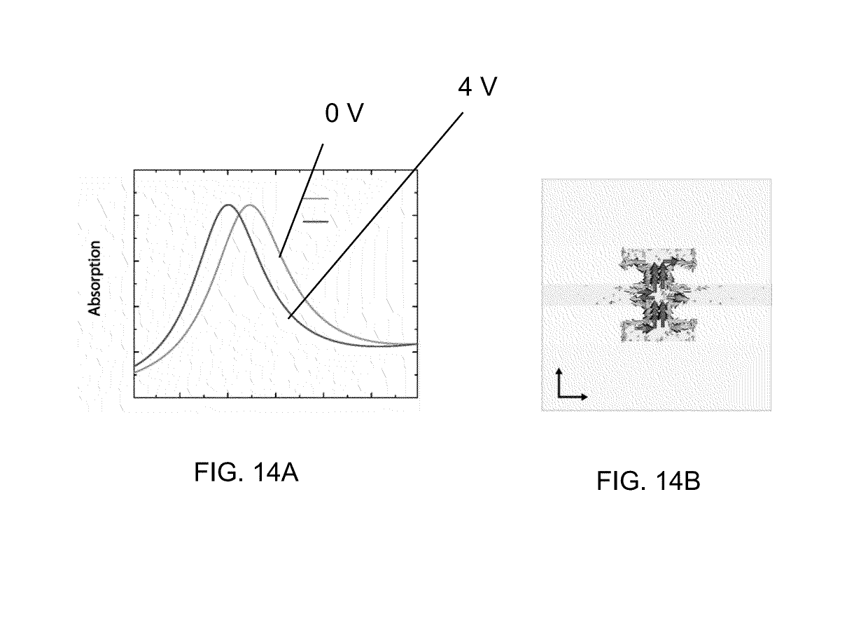

Results from the computational investigation are presented in FIG. 14A and FIG. 14B, which show that increasing the applied potential results in an increase in n_{5CB}. The real part of the refractive index was monotonically increased, which resulted in a redshift of the absorption peak frequency, as shown in FIG. 14A. At 4 V the peak absorption occurs at 2.51 THz and in the numerical model it was determined that n_{5CB} (Vbias=4)=2.01+i0.14. These results are in agreement with experimental results (see FIG. 13), although simulation indicates that the value of the peak absorption at 4 V applied bias is not significantly altered from the unbiased state. The change in refractive index determined by simulation was Δn=0.19. At a frequency of 2.62 THz, simulation predicted a change in A of 15% between zero and 4 V of applied bias, as shown in FIG. 14A. In contrast experimental results yielded a 30% change in absorption at the same frequency.

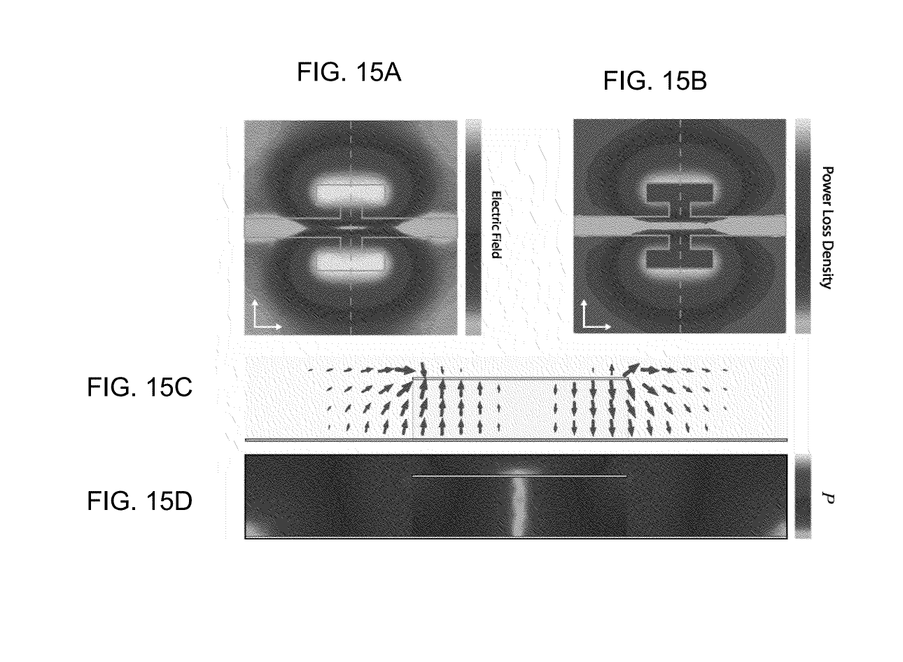

The particular mode exhibited by the presently-disclosed device at the maximum of the absorption, i.e. 2.62 THz, is examined. This can be explored by observation of the surface current density and magnitude of the THz electric field (plotted a plane centered between the two metallizations), as shown in FIG. 14B and FIG. 15A. It was found that the surface current density is similar to that found in prior investigations. The THz electric field is primarily localized underneath the ERR—in the same vicinity as the electric field provided by the bias shown in FIG. 12C. In contrast, the power loss density shown in FIG. 15B, reaches its strongest values just outside the ERR at the polyimide/LC interface. The magnitude of the electric field is also plotted as a vector field in FIG. 15C, and the power loss density in FIG. 15D; both in cross section. The form of the perfect absorption feature strongly depends on the value of the complex dielectric constant that the local terahertz electric field experiences. In particular the resonant frequency is set by the real part of the dielectric function, whereas the width of the absorption is determined by dielectric loss. Thus future designs can achieve greater frequency tuning of the absorption peak by altering the geometry such that the LC lies directly underneath the ERR, where the applied bias is greatest, as shown in FIG. 12C. As an alternative, one could take advantage of LC polymers, which could then act both as a supporting structure, and bias tunable dielectric.

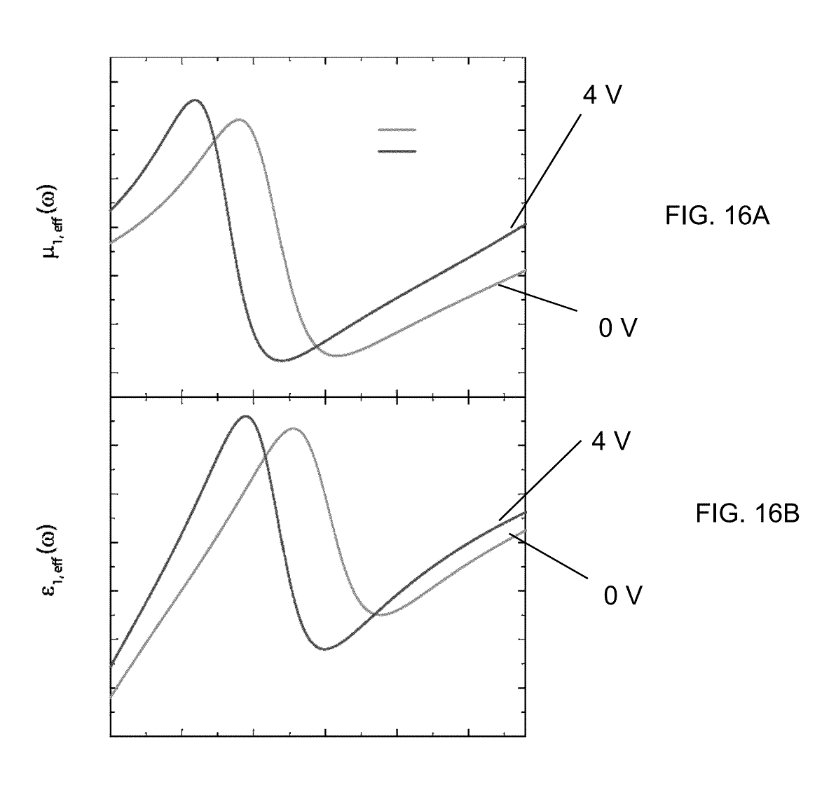

To frequency tune a metamaterial in which both the electric and magnetic properties have been designed, these properties were adjusted identically to preserve the desired electromagnetic response. Therefore dynamic magneto-dielectric metamaterials utilizing two separate unit cells may require complicated tuning mechanisms in order to maintain their properties. In contrast, a salient feature of the perfect absorber design is the ability to simultaneously adjust ∈(ω) and μ(ω) by simply altering the dielectric properties of the dielectric spacing layer, as demonstrated here with liquid crystal. This can be verified by plotting the extracted material parameters for the perfect absorber obtained from simulations utilizing a frequency dependent Drude model (plasma frequency ωₚ=2π×2175 THz and collision frequency ω_{c}=2π×6.5 THz). As shown in FIG. 16A and FIG. 16B, both the permittivity and permeability shift with little change in their shape for all applied biases investigated.

In conclusion, THz liquid crystal meta-material perfect absorber was electronically controlled. A 30% amplitude tuning of the absorption at 2.62 THz was achieved and a frequency tunability greater than 4% was realized. Because the both liquid crystal properties and metamaterial perfect absorbers are scalable, designs disclosed herein can be extended to both higher and lower frequencies. The prospect of electronically controlled metamaterial perfect absorbers have implications in numerous scientific and technological areas rich in applications, particularly in sensing, adaptive coded aperture imaging, and dynamic scene projectors.

### Example 2

### Liquid Crystal Tunable Single Pixel Terahertz Electromagnetic Absorber

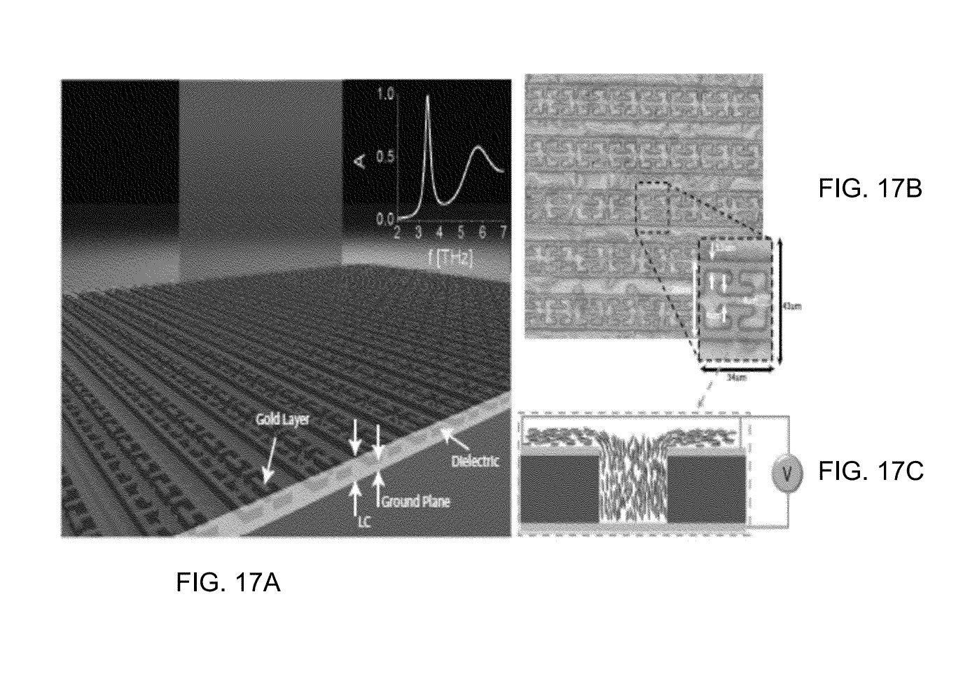

FIG. 17A illustrates a metamaterial absorber used in this Example. The first two resonant bands of the frequency dependent energy absorbtion, calculated numerically under normal incident condition, are plotted in the inset of FIG. 17A. The first resonance is generally sharper and can result in almost unity absorbtion, while the second resonant band extends over a broader frequency range.

FIG. 17B illustrates an optical microscope image of the metamaterial absorber that was fabricated with a single unit cell having the dimensions as labeled in the inset. Electric ring resonators were fabricated to form a rectangular array with 34 μm lattice spacing in the x direction and 43 μm along the y direction. Each unit cell was formed by a top section and bottom section electrically separated from each other through three 4 μm wide gaps. Both sections were connected to their neighbors via horizontal metallic wires (4.5 μm width) respectively and the entire array is connected to bias pads lying at the perimeter of the device. A 200/nm Au/Ti continuous metal ground plane was E-beam deposited on top of a supporting silicon (Si) substrate. A 5 μm thick liquid polyimide (PI-5878G,HD Microsystems™) dielectric layer was spin coated on top. Ultraviolet (UV) photolithography was used to pattern photoresist which was used for the deposition of 200 nm Au/Ti to create the ERR layer. ERR structures were used to serve as a hard mask for inductively coupled plasma and reactive ion etching in order to remove all polyimide not directly underneath the metamaterial layer. As tunable medium 4′-n-pentyl-4-cyanobiphenyl (5CB) was used. The LCs were deposited on the metamaterial array such that it completely enclosed the polymide and gold layers.

FIG. 17C shows a schematic of the cross section of the metamaterial absorber unit cell filled with LCs and the corresponding biasing scheme. The dimension of the LCs dimers has been enlarged only for the sake of clarity. When V=0 the orientation of the liquid crystal molecules has no preferential direction, while when V≠0 the LCs orient along the electric field lines. Impact of the boundaries is, however, not negligible. The influence of an interface may oppose the response to an electric field and the result is a threshold phenomena called the Freedericksz transition, this results into a suppression of the response to an applied static electric field. In the present case, for the LCs that occupies the space in between the polymide vertical walls the boundary interaction is not a nuisance but represents a benefit since it may promote the alignment of the LCs dimers with the applied electric field.

The reflectivity R (ω) was characterized from a frequency of 2-5 THz using a Fourier-transform infrared spectrometer combined with an infrared microscope, liquid helium-cooled Si-bolometer detector, and a germanium coated 6 μm mylar beamsplitter. The reflected energy was measured at an incident angle of 20° and it is normalized with respect to a gold mirror. With the measured reflectivity, the frequency dependent absorptivity defined as A(ω)=1−R(ω) was calculated. The transmissivity was zero because of the ground plane. The alignment of the LCs was realized through a square wave applied between the top metal layer and the ground plane. The peak to peak amplitude of the square wave was 10V whereas the modulation frequency was set to 1 kHz. Use of a modulated bias prevented free carrier build-up at the electrode metal interface which can occur for DC applied potentials. To prove the tunable response of the absorber, the absorptivity A(ω) was measured under two different biasing conditions, unbiased (V=0) and biased (V≠0). The tunable electromagnetic response for the first two resonances was studied.

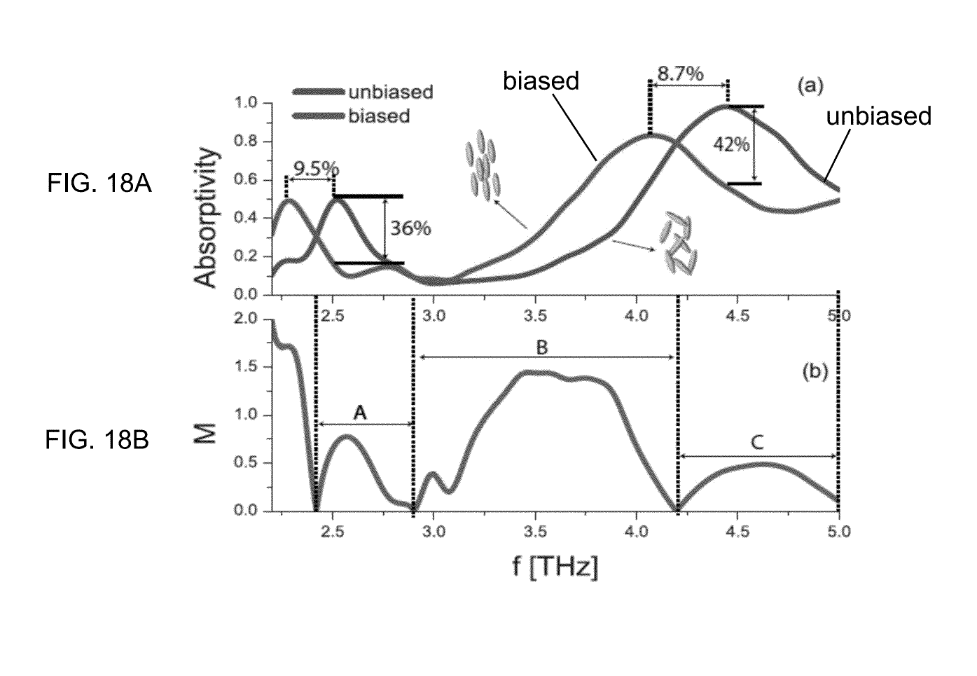

FIG. 18A is a plot of the measured absorptivity of the metamaterial absorber, showing biased state and unbiased state (i.e. the absorption of EM energy when the time varying electric field is applied). Frequency shift of 9.5% and 8.7% were recorded for the first and the second resonance respectively. This corresponds to a conspicuous intensity modulation of 36% and 42% respectively. The tuning performance can be summarized by the frequency dependent modulation factor M=|V_{nobias}−V_{bias}|/V_{nobias} plotted in FIG. 18B. The tuning mechanism leads to the formation of three bands of interests. As shown in FIG. 18B, with regard to the first resonance (see band A in FIG. 18B) the modulation peak is 78% at 2.57THz, of the two resonances this is the narrower. A comparable performance, but over a larger bandwidth was measured for the second resonance where the frequency shift is 8.7% and the amplitude modulation is 42%. Unlike the first order resonance, here the corresponding absorption peak on the unbiased curve is 98%, which is twice larger. In between the two resonances there is a broad transition band (band B) where the modulation factor is larger than 100%. It stays almost flat to 140% over a 600 GHz band.

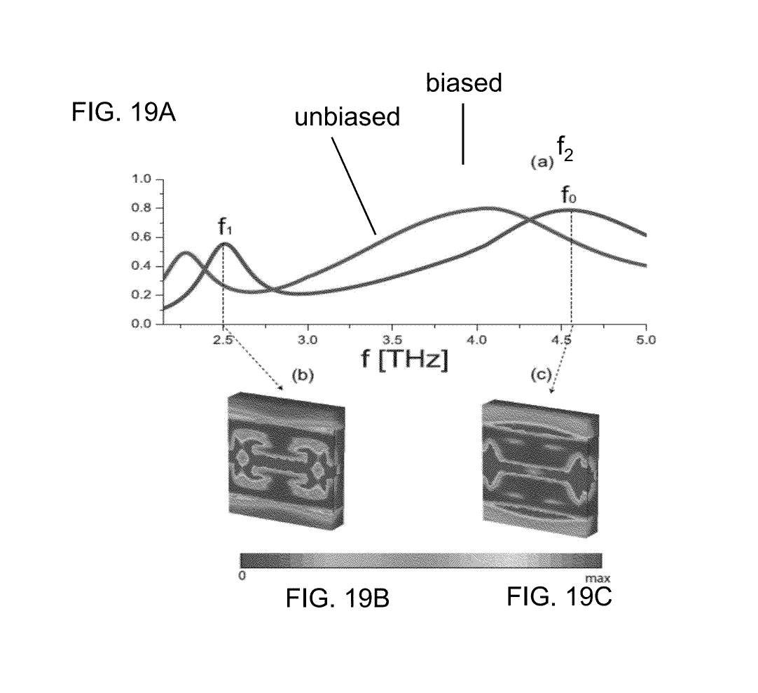

These results were also confirmed by numerical simulations (CST Microwave Studio 2012). The polymide layer was modeled with a relative complex permittivity ∈_{poly}=2.9+i0.08, whereas for the liquid crystal in the unbiased state the following value for the ordinary complex refractive index of n₀=1.80+i0.14 was used, as shown by the biased curve in FIG. 19A. In order to explain the frequency shift seen experimentally, the effect of birefringence was modeled as an increase in the real part of the liquid crystals refractive index only. The matching with the biased experimental curve is achieved when the extraordinary refractive index is nₑ=2.06+i0.14 (see biased curve in FIG. 19A). The above outcome tells that the birefringence effect leads to a total change in the real part of the refractive index of Δn=0.26. In order to explain the different mechanisms behind the energy absorption, 3D the power loss distribution for a single unit cell was also computed at the two resonant frequencies, f₁ and f₂ (see FIG. 18A). Since at THz losses in the metal are negligible, the absorbtion of energy takes place mainly through dielectric losses. As shown in FIG. 19B at f=f₁ most of the energy dissipation is localized in the volume inside the electric ring resonator with the region in between the parallel plates. The parallel plates provide a mean for the electric component of the light to couple to the ERR while the magnetic field coupling takes place thanks to the near field interaction between the ground plane and the ERR. At the higher frequency f=f₂, as shown in FIG. 19C, the interaction between the neighboring unit cells starts playing an important function, resulting in a stronger energy dissipation in the volume of space separating the ERRs along the vertical direction and filled with LCs. This result indicates that a larger amount of the tunable active material may contribute to the absorption of the electromagnetic energy.

Electronically tunable single pixel metamaterial absorber was realized by exploiting the birefringence shown in 5CB liquid crystals at THz. The absorption of energy was measured for the first and second resonance and it was demonstrated that large modulation factors up to 140% may be possible. Biasing the metamaterial pixel normally to the absorber plane resulted into a 9.5% and 8.7% frequency shift and in 36% and 42% amplitude modulation for the first and the second resonance respectively. All experimental results were in agreement with numerical simulations.

### Example 3

### Liquid Crystals Metamaterials Perfect Absorbers Spatial Light Modulator for THz Applications

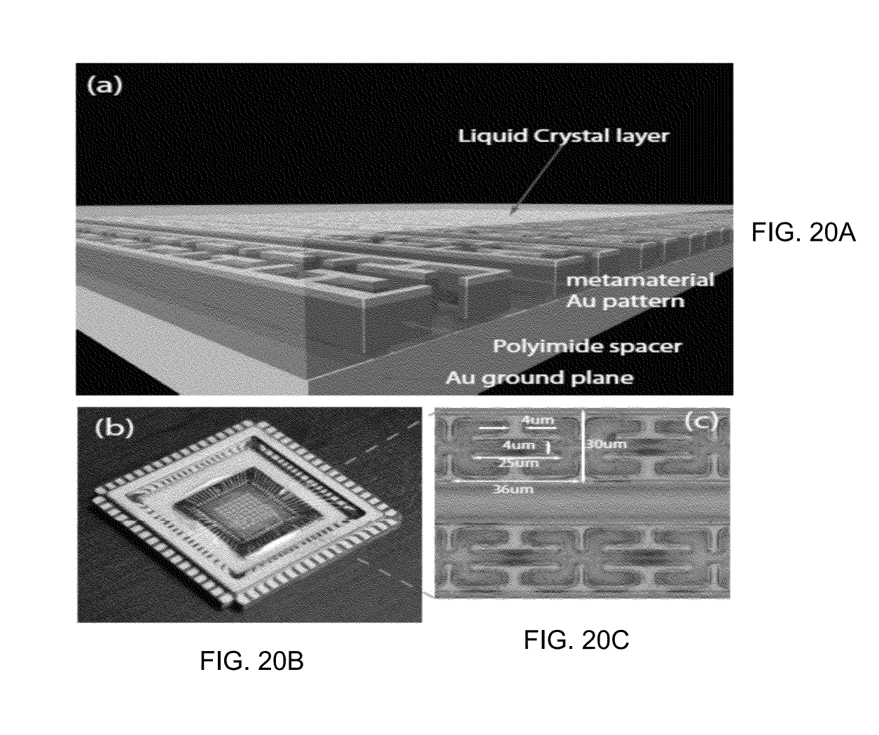

FIG. 20A shows a 3-dimensional drawing of an array of metamaterial perfect absorber, as the one used in this example, covered with a layer of liquid crystals. For the sake of understanding the MPA array and the LC coat were virtually cut along the directions orthogonal and parallel to the ERRs lines. The ERR array was separated from the ground plane through a dielectric layer. In order to gain control over the metamaterial response, all the non-metallic material that is not laying under the ERR layers was removed and subsequently the space was filled with LCs. The refractive index of the supporting dielectric spacer impacts tailoring of the electromagnetic response of the metamaterial. Its real part sets the resonance frequency while dielectric losses influence the resonance bandwidth. When liquid crystal (LC) is added its refractive index strongly influences the metamaterial absorption resulting in a resonance redshift. The presence of a cap layer further shifts the working frequency to even lower values. This is somewhat useful since it contribute to increasing the λ/a ratio, where a is the dimension of the metamaterial unit cell. In addition to that, given a certain mechanism for changing the orientation of the LC rod shaped molecules the LC intrinsic strong birefringence can be used to tune the metamaterial response. For the purposes of this Example, a static electric field was used to adjust the orientation of the dimers.

The spatial light modulator used in this Example was composed of a 6×6 pixels array. The pixel pitch was 480 μm×466 μm. Electric ring resonators forming the top metallic plane of each pixels were fabricated to form a rectangular array with 45 μm lattice spacing in the horizontal direction and 30 μm along the vertical direction. Each unit cell was formed by a top section and bottom section electrically separated from each other through three 4 μm wide gaps. Both sections were connected to their neighbors via horizontal 4 μm width metallic wires. All ERRs arrays forming the top layer of each individual pixel were all electrically connected through 200 μm wide continuous gold lines. The ground plane on the other hand, formed by 200 nm Au/Ti E-beam deposited layer on top of a supporting silicon substrate was pixelated into isolated square islands with dimensions matching those of the ERR pixel. To avoid electrical short-circuit between the ground plane pads, a 10 nm thermally grown SiO₂ layer was added to the wafer. 4 μm Au metallic lines electrically connected each ground planes and the top continuous metallic layer to rectangular pads arranged around the pixels matrix. The dielectric spacer was formed by spin coating a 5.2 μm thick liquid polyimide layer (PI-2611 from HD Microsystems™). Ultraviolet (UV) photolithography was used to pattern photoresist which was used for the deposition of 200 nm Au/Ti and for creating both the ground plane and ERR layers. The ERR structures served as a hard mask for inductively coupled plasma and reactive ion etching in order to remove all polyimide not directly underneath the metamaterial layer and form the trenches for hosting the LC. In order to further improve the control over the MPA response, small undercuts were created by over overetching of the polyimide. The fabricated device was glued to a chip carried and wire-bonded to it. FIG. 20B illustrates a photograph of the SLM seating in the chip carrier, whereas FIG. 20C illustrates an optical microscope image of the metamaterial perfect absorber and the corresponding unit cell dimension used in this Example.

Highly birefringent and highly anisotropic isothiocyanate-based liquid crystal mixture, LCMS-1107 from LC Matters, was employed. The mixture was first dropped with a pipette on the metamaterial SLM array and was allowed to sit for few days in order to allow the evaporation of the water content. The surface tension of the LC combined with the smooth gold surfaces of the metamaterial resulted in poor adhesion of the LC to the device face. The above drying step improved the grip of the LC substantially. A final blow of He gas carefully pointed toward the MPA surface improved the uniformity of the LC cap layer.

Prior to perform the optical characterization the electrical connection were tested in order to check for possible short-circuits between the top metal layer and the ground planes. The experiment was carried out at THz using a Hyperion-2000 infrared microscope connected to a FTIR spectrometer. The sample was illuminated at an incident angle of 20° with a Hg-arc lamp source. The frequency dependent absorptivity A(ω)=1−R(ω) was measured by means of a liquid He cooled Si bolometer detector in the frequency range [2-6] THz where the metamaterial resonates. Moreover, the sample was placed in a plexiglass box and a continuous flow of dry air guaranteed a level of humidity below 1%.

The orientation of the LC dimers was electronically controlled by biasing each pixel with a 15 V peak-to-peak square waveform oscillating a 1 kHz.

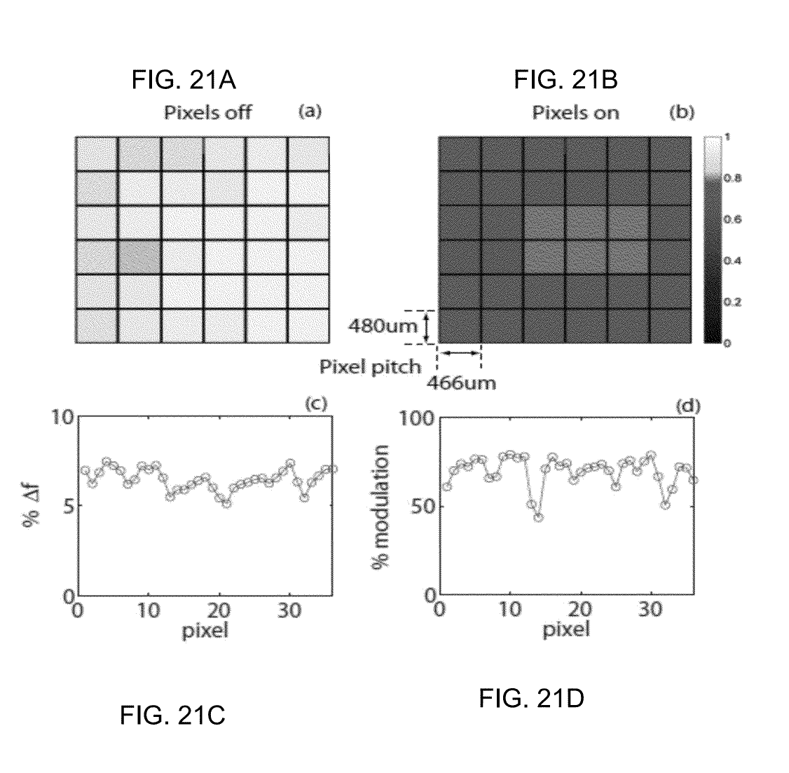

First the absorptivity A(ω) for each pixel was measured in the unbiased state, then it was measured in the biased conditions. FIG. 21A and FIG. 21B show the pixelated maps of the absorptivity at f=3.7THz in the unbiased and biased case respectively. The irregularities in the LC layer thickness across the SLM matrix resulted in small fluctuation of the resonant frequencies of the different pixels. The uniformity of the SLM response frequency shift can be described in terms of the percentage frequency shift Δf %=(f0_{off}−f0ₒₙ)/f0_{off}, as shown in FIG. 21C, where f0_{off} and f0ₒₙ are the measured resonance frequencies for each pixel in the off and on state. Experimental measurements reported an average frequency shift of 6.5% and a standard deviation of 0.6%. Whereas the ability of the MPA SLM to modulate is analyzed in terms of the modulation factor M (f0ₒₙ)=[R_{bias}−R_{unbias}]/R_{bias}. The average pixels performance indicates a modulation mean value of 70% ad standard deviation of 8.4%, as shown in FIG. 21D.

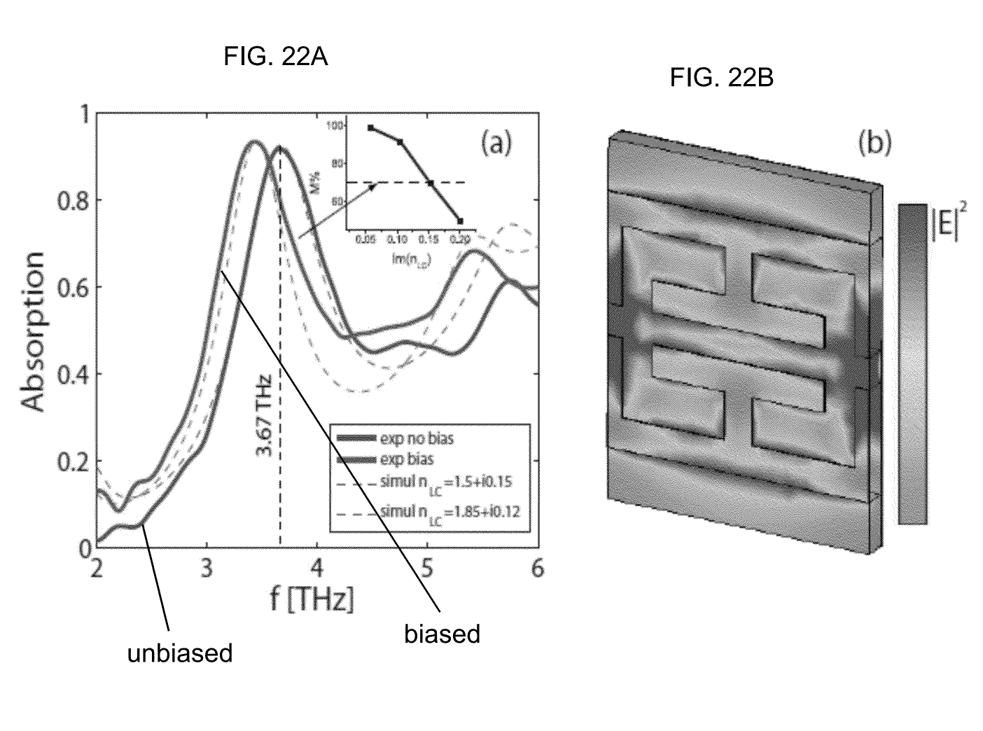

In order to provide a quantitative description of the mechanism responsible for the modulation of the MPA response, the measured frequency dependent absorptivities in the unbiased and biased state were matched for an individual pixel with those obtained through numerical simulations, as shown in FIG. 22A. Calculations, performed using the commercial tool CST Microwave, were carried out on a single unit cell having the same dimension as the real sample and by applying periodic boundary conditions. The liquid crystal was modeled as a dispersion-less, homogeneous and isotropic medium in the bandwidth of interest. Whereas the Au was treated as a lossy medium. In the unbiased case the calculated absorption curve matched with experiment when the ordinary refractive index of the LC mixture is n_{LCu}=n₀=1.5+i0.15. Whereas, the value of the extraordinary refractive index that matches the MPA response when biased is n_{LC}=nₑ=1.85+i0.12. The overall change in the real part of the refractive index is Δn=0.35. The model used for the simulation also included a 5 μm thick LC cap layer sitting above the metamaterial. It was assumed that the refractive index of the LC forming the cap layer is not influenced by the biasing voltage.

The inset of FIG. 22A illustrates a numerical study of the modulation factor when dielectric losses in the LC are reduced. It is shown that by cutting losses by 50% performances could be enhanced significantly and almost 100% modulation could be achieved. FIG. 22B illustrates the spatial distribution of the intensity of the electric field inside the LC and polyimide layers at resonance. The strongest absorption takes place around the lateral vertical gaps and extends in the region between the two parallel plates. Moreover, a non-negligible contribution comes also from the top and bottom metallic lines.

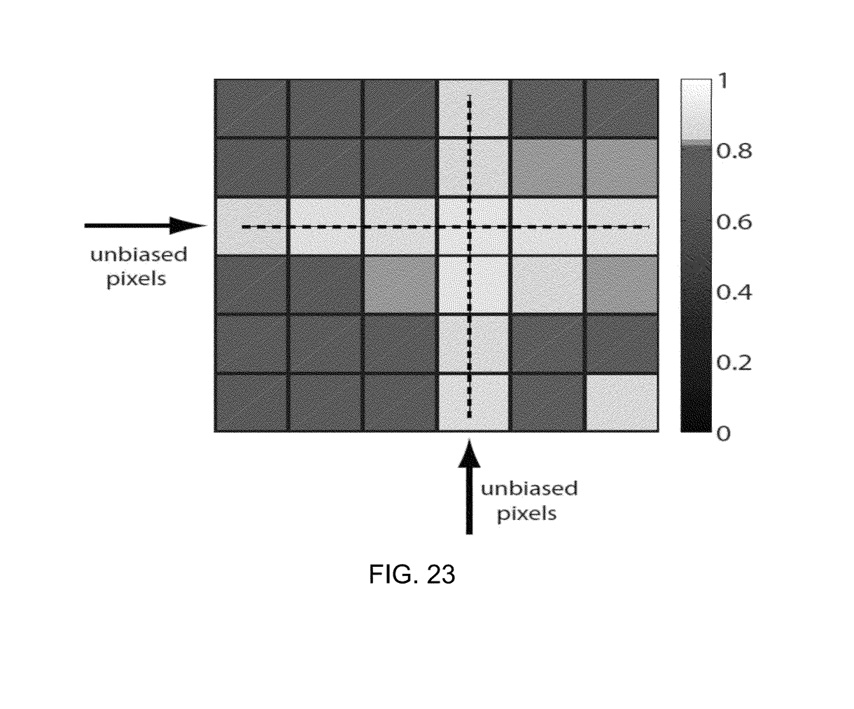

The ability of the reconfigurable MPA to work as a spatial light modulator is confirmed in the intensity map plotted in FIG. 23 that shows a pixellated image of a cross pattern created by turning off only selected pixels at 3.725THz. The two dead pixels laying outside the cross at the bottom right of the main area could be related to the inevitable degradation of the LC under the exposure of air. Also, another factor could be the degeneracy of the LC resistivity arising from the ions trapping near the polyimide interface which is a known concern for isothiocyanate-based compounds. Lower resistivity could lead to a weaker electric field intensity across the LC volume which could results in incomplete rotation of the LC molecule and hence reduced birefringence.

In some embodiments, a metamaterial perfect absorber of the present disclosure includes a front metamaterials layer, a back layer, and a dielectric layer in between the front layer and the back layers, wherein the dielectric layers includes one or more environmentally responsive materials. In some embodiments, environmentally responsive materials include pyroelectric materials, phase change materials, liquid crystal materials and combinations thereof.

In some embodiments, a multi-pixel MMPA-based device, such as detector or SLM device, including one or more metamaterial perfect absorber of the present disclosure, including a front metamaterials layer, a back layer, and a dielectric layer in between the front layer and the back layers, wherein the dielectric layers includes one or more environmentally responsive materials, such as, for example, pyroelectric materials, phase change materials, liquid crystal materials and combinations thereof.

In some embodiments, a metamaterial perfect absorber includes a first patterned metallic layer, a second metallic layer electrically isolated from the first patterned metallic layer by a gap, and an environmentally responsive dielectric material positioned in the gap between the first patterned metallic layer and the metallic second layer.

In some embodiments, a detector includes a first patterned metallic layer, a second metallic layer electrically isolated from the first patterned metallic layer by a gap, and a pyroelectric material disposed in the gap between the first patterned metallic layer and the second metallic layer, and a voltage meter configured to record voltage generated in the pyroelectric material due to a change in temperature in the pyroelectric material.

In some embodiments, a spatial light modulator includes a plurality of pixels, each pixel comprising a first patterned metallic layer, a second metallic layer electrically isolated from the first patterned metallic layer by a gap, and a phase change material positioned in the gap between the first patterned metallic layer and the second metallic layer, and a biasing source electrically connected to the pixels to switch the pixels between an absorption state and a reflection state.

In some embodiments, an imaging system includes a source of radiation to irradiate an object to be imaged, a spatial light modulator having a plurality of pixels, each pixel comprising a first patterned metallic layer, a second metallic layer electrically isolated from the first patterned metallic layer by a gap, and a phase change material positioned in the gap between the first patterned metallic layer and the second metallic layer, and a biasing source electrically connected to the pixels to switch the pixels between an absorption state and a reflection state, and a radiation detector, wherein the spatial light modulator is configured to receive radiation reflected from the object and to reflect the radiation in a desired manner to the radiation detector.

All patents, patent applications, and published references cited herein are hereby incorporated by reference in their entirety. While the devices and methods of the present disclosure have been described in connection with the specific embodiments thereof, it will be understood that they are capable of further modification. Furthermore, this application is intended to cover any variations, uses, or adaptations of the devices and methods of the present disclosure, including such departures from the present disclosure as come within known or customary practice in the art to which the devices and methods of the present disclosure pertain.

What we claim is:

1. A metamaterial perfect absorber comprising:
a first patterned metallic layer;
a second metallic layer electrically isolated from the first patterned metallic layer by a gap; and
an environmentally responsive dielectric material positioned in the gap between the first patterned metallic layer and the metallic second layer.

2. The absorber of claim 1 wherein the first patterned metallic layer comprises a two-dimensional array of metallic resonators spaced away from one another.

3. The absorber of claim 2 wherein the environmentally responsive dielectric material is contained within the gap.

4. The absorber of claim 1 wherein the second metallic layer is a continuous conductive layer.

5. The absorber of claim 1 wherein the environmentally responsive material is a phase change material.

6. The absorber of claim 1 wherein the environmentally responsive material is a pyroelectric material.

7. A detector comprising:
a first patterned metallic layer;
a second metallic layer electrically isolated from the first patterned metallic layer by a gap;
pyroelectric material disposed in the gap between the first patterned metallic layer and the second metallic layer; and
a voltage meter configured to record voltage generated in the pyroelectric material due to a change in temperature in the pyroelectric material.

8. The detector of claim 7 wherein the first patterned metallic layer comprises a two-dimensional array of metallic resonators spaced away from one another.

9. The detector of claim 7 wherein the second metallic layer is a continuous conductive layer.

10. The detector of claim 7 further comprising an amplifier to the pyroelectric material to amplify a signal from the pyroelectric material to the voltage meter.

11. The detector of claim 7 further comprising a light modulator configured to modulate incident light on the pyroelectric material.

12. A spatial light modulator comprising:
a plurality of pixels, each pixel comprising a first patterned metallic layer, a second metallic layer electrically isolated from the first patterned metallic layer by a gap, and a phase change material positioned in the gap between the first patterned metallic layer and the second metallic layer; and
a biasing source electrically connected to the pixels to switch the pixels between an absorption state and a reflection state.

13. The spatial light modulator of claim 12 wherein the first patterned metallic layer comprises a two-dimensional array of metallic resonators spaced away from one another.

14. The spatial light modulator of claim 12 wherein the second metallic layer is a continuous conductive layer.

15. The spatial light modulator of claim 12 wherein the phase-change material is a liquid crystal material.

16. An imaging system comprising:
a source of radiation to irradiate an object to be imaged;
a spatial light modulator comprising:
a plurality of pixels, each pixel comprising a first patterned metallic layer, a second metallic layer electrically isolated from the first patterned metallic layer by a gap, and a phase change material positioned in the gap between the first patterned metallic layer and the second metallic layer, and
a biasing source electrically connected to the pixels to switch the pixels between an absorption state and a reflection state; and
a radiation detector, wherein the spatial light modulator is configured to receive radiation reflected from the object and to reflect the radiation in a desired manner to the radiation detector.

17. The imaging system of claim 16 wherein the first patterned metallic layer comprises a two-dimensional array of metallic resonators spaced away from one another.

18. The imaging system of claim 16 wherein the second metallic layer is a continuous conductive layer.

19. The imaging system of claim 16 wherein the phase change material is a liquid crystal material.

20. The imaging system of claim 16 wherein thee spatial light modulator is configured to act as a coded aperture mask.
